(19) United States
(12) Patent Application Publication
(10) Pub. No.: US 2009/0121374 A1
(43) Pub. Date: May 14, 2009

(54) METHOD OF MANUFACTURING CRYSTAL ORIENTED CERAMICS

(75) Inventors: Daisuke Shibata, Tokai-shi (JP); Masaya Nakamura, Nagoya (JP); Hideki Kimura, Chita-gun (JP); Toshiatsu Nagaya, Kuwana-shi (JP); Hirotaka Yamaguchi, Anjo-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/260,191

(22) Filed: Oct. 29, 2008

(30) Foreign Application Priority Data
Nov. 8, 2007 (JP) 2007-290974
Nov. 8, 2007 (JP) 2007-290975

(51) Int. Cl. C04B 35/46; B29C 67/00

(52) U.S. Cl. 264/40.1; 264/332

(57) ABSTRACT

A method of manufacturing a crystal oriented ceramics is disclosed. The method comprises preparing step, mixing step, shaping step and sintering method. At least one of anisotropically shaped powder, used as raw material, and a compact, formed by shaping step, is selected to have an orientation degree of 80% or more with a full width at half maximum (FWHM) of 15° or less according to a rocking curve method. A microscopic powder, having an average grain diameter one-third or less that of anisotropically shaped powder, is prepared for mixing therewith to prepare raw material mixture. The raw material mixture is shaped into the compact so as to allow oriented planes of anisotropically shaped powder to be oriented in a nearly identical direction. In a sintering step, anisotropically shaped powder and microscopic powder are sintered with each other to obtain the crystal oriented ceramics.

### CROSS REFERENCE TO RELATED APPLICATIONS

This application is related to Japanese Patent Application Nos. 2007-290974 and 2007-290975, both filed on Nov. 8, 2007, the contents of which are hereby incorporated by reference.

### BACKGROUND OF THE INVENTION

1. Technical Field of the Invention

The present invention relates to methods of manufacturing crystal oriented ceramics and, more particularly, to a method of manufacturing a crystal oriented ceramics formed in a polycrystalline body having a principal phase formed of an isotropic perovskite-based compound composed of crystal grains each of which has an oriented specific crystal plane.

2. Description of the Related Art

A polycrystalline body, composed of ceramics, has been widely used in various sensors such as sensors for detecting, for instance, a temperature, heat, gas and ions or the like. Further, the polycrystalline body has been utilized in electronic fields of electronic component parts such as a capacitor, a resistor and an integrated circuit substrate or the like, optical fields, magnetic recording devices or the like. Especially, the polycrystalline body (hereinafter referred to as “piezoelectric ceramics”), composed of ceramics having a piezoelectric effect, has high performance with increased degree of freedom in shape while making it relatively easy to perform material design. Thus, the piezoelectric ceramics has been widely used in fields of electronics or mechatronics.

The piezoelectric ceramics comprises a ferroelectric ceramics subjected to a so-called polarization treatment in which an electrical field is applied onto the ferroelectric ceramics to allow a ferroelectric domain to be aligned in a certain orientation. In order to have the piezoelectric ceramics to have intrinsic polarizations aligned in the certain orientation, the piezoelectric ceramics may preferably take the form of an isotropic perovskite-based compound with the intrinsic polarizations oriented in three-dimensional relationship. Therefore, a major portion of the piezoelectric ceramics in practical use is composed of an isotropic perovskite-based ferroelectric ceramics.

As the isotropic perovskite-based ferroelectric ceramics, there have been known ceramics of, for instance, Pb(Zr.Ti)O₃ (hereinafter referred to as ‘PZT’), PZT-3-component family in which a lead-family composite perovskite is added as a third element to PZT, BaTiO₃ and Bi_{0.5}Na_{0.5}TiO₃ (hereinafter referred to as “BNT”) or the like.

Among these, the piezoelectric ceramics of the lead family, represented by PZT, has a higher piezoelectric characteristic than that of the other piezoelectric ceramics and takes a major share of the piezoelectric ceramics currently in practical use. However, the piezoelectric ceramics of such a lead family contains lead oxide with high vapor pressure, with an accompanying issue with an increase of environmental burdens. Therefore, it has been desired to provide a piezoelectric ceramics with less amount of lead or unleaded state yet having a piezoelectric characteristic equivalent to that of PZT.

Meanwhile, among unleaded piezoelectric materials, BaTiO₃ ceramics has a relatively high piezoelectric characteristic and has been used in sonar devices or the like. Further, a solid solution of BaTiO₃ and other unleaded perovskite-based compound (such as, for instance, BNT or the like) exhibits a relatively high piezoelectric characteristic. However, these unleaded piezoelectric ceramics have problems with piezoelectric characteristics being lower than that of PZT.

In order to address such issues, an attempt has heretofore been made to provide various piezoelectric ceramics. These include, for instance, isotropic perovskite-based potassium sodium niobate, exhibiting high piezoelectric characteristic relative to those of the unleaded family, and a piezoelectric ceramics composed of such a solid solution (see U.S. Pat. No. 6,387,295 and U.S. Pat. No. 7,309,450 and Japanese Patent Application Publication Nos. 2003-300776, 2003-306479, 2003-342069 and 2003-342071). However, an issue arises in that these unleaded piezoelectric ceramics cannot exhibit adequately higher piezoelectric characteristic than those of the piezoelectric ceramics of the PZT family.

Under such a background, a research and development work has been done to provide a piezoelectric element composed of a piezoelectric ceramics having an anisotropy in shape and including ceramic crystal grains with intrinsic polarizations preferentially oriented in a single plane (see Japanese Patent Application Publication No. 2004-7406).

In general, it has been known that the piezoelectric characteristics of the isotropic perovskite-based compounds are different from each other depending on orientations crystal axes. Therefore, if it is possible to allow the crystal axes with high piezoelectric characteristics to be oriented in a certain direction, then the use of the anisotropy in piezoelectric characteristic can be maximized with a possibility of obtaining a piezoelectric ceramics with increased performance. As disclosed in Japanese Patent Application Publication No. 2004-7406, a manufacturing method has been utilized. In this method, a plate-like powder having a given composition is used as a reactive template and the plate-like powder and a raw material powder are sintered to cause a specific crystal plane orientation to be obtained. With such a manufacturing method, a crystal oriented ceramics can be manufactured in a structure with the specific crystal plane oriented at a high orientation degree with accompanying high performance.

As shown in FIGS. 3 to 6, the crystal oriented ceramics can be manufactured in a manner described below.

That is, first, as shown in FIG. 3, anisotropically shaped plate-like powders 1, each having a given composition, are prepared as reactive templates. In addition, raw material powders 2 for producing an isotropic perovskite-based compound when reacted with the plate-like powders 1 during a sintering step. Subsequently, a solvent, a binder, a plasticizer and a dispersant or the like are mixed to the plate-like powders 1 and the raw material powders 2, thereby preparing slurry 3. Within the slurry 3, the plate-like powders 1 and the raw material powders 2 are dispersed in a dispersion medium composed of the solvent, the binder, the plasticizer and the dispersant or the like.

Next, the slurry 3 is shaped in, for instance, a sheet form to prepare a compact 5 as shown in FIG. 4. When this takes place, as shown in FIG. 4, the compact 5 is subjected to shear stress applied during the shaping step, causing the anisotropically shaped plate-like powders 1 to be aligned in a nearly identical direction. Subsequently, the compact 5 is heated for sintering. When this takes place, as shown in FIG. 5, the plate-like powders 1 act as the reactive templates to react with surrounding raw material powders 2, causing the plate-like powders 1 to form crystals while producing the perovskite-based compounds, respectively. In addition, as the sintering step is promoted, the plate-like powders 1 grow up in reaction with the raw material powders 2. This results in a capability of obtaining a crystal oriented ceramics 8 composed of crystal grains (oriented grains) 7 with a specific crystal plane being oriented.

However, with the manufacturing method of such a related art, even if an attempt is made to manufacture the crystal oriented ceramics with the plate-like powders being oriented, an issue is sometimes encountered with the occurrence of variation in orientation degrees of the crystal grains subsequent to the sintering step. This results in a difficulty of obtaining the crystal oriented ceramics with an increased orientation degree.

Further, during a step of manufacturing a polycrystalline body (crystal oriented ceramics) composed of ceramics upon sintering the plate-like powders and the raw material powders, the plate-like powders and the raw material powders, different from each other in grain diameter, tend to be sintered with an accompanying issue arising with a difficulty of obtaining a dense polycrystalline body.

### SUMMARY OF THE INVENTION

The present invention has been completed with a view to addressing the above issues and has an object to provide a method of manufacturing a crystal oriented ceramics to enables a stable production of the crystal oriented ceramics with an increased orientation degree.

To achieve the above object, a first aspect of the present invention provides a method of manufacturing a crystal oriented ceramics formed in a polycrystalline body having a principal phase formed of an isotropic perovskite-based compound composed of crystal grains with a specific crystal plane A of each crystal grain being oriented. The method comprises: preparing an anisotropically shaped powder composed of anisotropically shaped oriented grains formed of a perovskite-based compound with crystal planes, having lattice consistency with the specific crystal plane A, which are oriented to form oriented planes, and a microscopic powder having an average grain diameter one-third or less that of the anisotropically shaped powder and producing the isotropic perovskite-based compound when sintered with the anisotropically shaped powder; mixing the anisotropically shaped powder and the microscopic powder to prepare a raw material mixture; shaping the raw material mixture to form a compact so as to allow the oriented planes of the anisotropically shaped powder to be oriented in a nearly identical direction; and sintering the compact upon heating the same to cause the anisotropically shaped powder and the microscopic powder to be sintered with each other to obtain the crystal oriented ceramics. At least one of the anisotropically shaped powder and the compact has a full width at half maximum (FWHM) of 15° or less according to a rocking curve method.

In carrying out the manufacturing method of the present invention, the preparing step, the mixing step, the shaping step and the sintering step are conducted to manufacture the crystal oriented ceramics.

The most noteworthy point of the present invention is to use the anisotropically shaped powder and the compact.

That is, at least one of the anisotropically shaped powder and the compact is selected to have the full width at half maximum (FWHM) of 15° or less according to the rocking curve method. In measuring the full width at half maximum (FWHM) of the anisotropically shaped powder, the full width at half maximum (FWHM) of the oriented plane of the anisotropically shaped powder is measured according to the rocking curve method. In measuring the full width at half maximum (FWHM) of the compact, the full width at half maximum (FWHM) of the oriented plane of the crystal grain forming the compact is measured. Thus, at least one of the anisotropically shaped powder and the compact having the orientation degree of 80% or more and the full width at half maximum (FWHM) of 15° or less according to the rocking curve method is adopted. This allows the crystal oriented ceramics to be reliably obtained in structure with extremely increased piezoelectric characteristic.

In the shaping step, the raw material mixture is shaped upon receipt of shear stress by, for instance, a doctor blade method or the like. This allows the raw material mixture to be shaped to cause the oriented panes of the anisotropically shaped powder to be oriented in a nearly identical direction, thereby preparing the compact. However, it is extremely difficult to cause the oriented panes of the anisotropically shaped powder to be oriented in a completely identical direction and an oriented state of the anisotropically shaped powder in the compact provides a remarkable adverse affect on a characteristic of the crystal oriented ceramics. To this end, a need arises for evaluating the oriented state of the anisotropically shaped powder or the compact.

In one aspect of the present invention, the method of manufacturing the crystal oriented ceramics may further preferably comprise evaluating the oriented planes of the oriented grains in the compact upon measuring an orientation degree according to a Lotgering method and the fall width at half maximum (FWHM) according to the rocking curve method and selecting the compact having the orientation degree of 80% or more with the full width at half maximum (FWHM) of 15° or less. This enables the crystal oriented ceramics to be further reliably obtained in structure with extremely increased piezoelectric characteristic. However, no linearly proportional relationship is necessarily exhibited between the orientation degree, according to the Lotgering method, of the compact before the sintering step and the orientation degree of a finally obtained crystal oriented ceramics. Especially, it is turned out that the compact having the increased orientation degree has such a remarkable tendency.

This is deemed to arise from the occurrence of variation in an inclination of each crystal grain of the compact. Thus, with the first aspect of the present invention, the evaluating step is conducted with a focus on not only the orientation degree according to the Lotgering method but also the full width at half maximum according to the rocking curve method. Thus, the compact having the full width at half maximum of 15° or less is selected. This makes it possible to select the compact having increased orientation degree with less variation in the inclination of the oriented grain per se. Conducting the sintering step using such a compact results in a capability of producing an anisotropically shaped crystal composed of the isotropic perovskite-based compound inherited with an orientation azimuth of the oriented grain, enabling the crystal oriented ceramics to be further reliably manufactured in structure with extremely high orientation degree. In such a case, further, it becomes possible to obtain a highly dense crystal oriented ceramics. The crystal oriented ceramics with increased densification and increased orientation has excellent piezoelectric characteristic such as a piezoelectric d₃₃ constant and a dielectric characteristic such a low dielectric loss or the like, while having less variation in the piezoelectric characteristic and the dielectric characteristic when subjected to temperature variation. This makes it possible to use the crystal oriented ceramics to be utilized as a piezoelectric element or dielectric element with increased performance.

According to the present invention, as set forth above, it becomes possible to provide a method of manufacturing a crystal oriented ceramics for enabling a stable production of crystal oriented ceramics with increased orientation degree.

According to a second aspect of the present invention, the step of preparing the anisotropically shaped powder may preferably comprise measuring the full width at half maximum (FWHM) of the oriented planes according to the rocking curve method and adopting the anisotropically shaped powder having the full width at half maximum (FWHM) of 10° or less.

In the shaping step, the raw material mixture, composed of the anisotropically shaped powder and the compact, is applied with shear stress by, for instance, the doctor blade method or the like. The raw material mixture is shaped into the compact with the oriented panes of the anisotropically shaped powder oriented in a nearly identical direction. In this case, even if the anisotropically shaped powder is oriented in the compact, variation takes place in the oriented planes of the anisotropically shaped powder per se. This makes it difficult for the oriented planes to be oriented in the compact in an identical direction. As a result, this causes variation to easily occur in the orientation degree of the crystal oriented ceramics obtained after sintering the compact, with accompanying occurrence of variation in a piezoelectric characteristic such as a piezoelectric d₃₃ constant.

With the second aspect of the present invention, the raw material mixture includes the anisotropically shaped powder the full width at half maximum (FWHM) of 10° or less according to the rocking curve method, Thus, when the shaping step is conducted to allow the oriented planes of the anisotropically shaped powder to be oriented in a nearly identical direction, the compact can be prepared in a structure with greatly less variation in the oriented planes of the anisotropically shaped powder in the compact. As a result, the crystal oriented ceramics can have minimized variation in orientation degrees on a stage after the completion of the sintering step. This allows the crystal oriented ceramics to be further reliably obtained in structure with extremely increased piezoelectric characteristic.

Further, by using the anisotropically shaped powder with the full width at half maximum (FWHM) of 10° or less, an improved sintering effect can be obtained between the anisotropically shaped powder and the microscopic powder. Therefore, it becomes possible to manufacture a crystal oriented ceramics with further increased density. With such a view in mind, a crystal oriented ceramics can be obtained in structure with excellent piezoelectric characteristic.

### BRIEF DESCRIPTION OF THE DRAWINGS

FIG. 1A is an illustrative view representing an X-ray diffraction pattern of a compact with oriented grains being oriented according a method of manufacturing a crystal oriented ceramics according to the present invention.

FIG. 1B is an illustrative view representing an X-ray diffraction pattern of a compact in the absence of oriented grains according a method of manufacturing a crystal oriented ceramics according to the related art.

FIG. 1C is an illustrative view representing an X-ray diffraction pattern of a compact in which a peak intensity of the X-ray diffraction pattern, shown in FIG. 1B, is subtracted from a peak intensity of the X-ray diffraction pattern shown in FIG. 1A.

FIG. 2 is an illustrative view representing the relationship between an orientation degree according to a Lotgering method for the compact, manufactured by the method of the present invention, and a full width at half maximum (FWHM) of the compact according to a rocking curve method.

FIG. 3 is an illustrative view representing a structure of slurry obtained by mixing plate-like powders and raw material powders resulting from a manufacturing method of the related art.

FIG. 4 is an illustrative view representing a structure of a compact of the related art, composed of the plate-like powders and the raw material powders, in which the plate-like powders are internally oriented in a nearly constant direction.

FIG. 5 is an illustrative view representing how anisotropically shaped crystal growth in the compact being sintered.

FIG. 6 is an illustrative view representing a structure of a crystal oriented ceramics obtained by the manufacturing method according to the present invention.

### DETAILED DESCRIPTION OF PREFERRED EMBODIMENTS

Now, a method of manufacturing a crystal oriented ceramics according to the present invention will be described below in detail with reference to the accompanying drawings. However, the present invention is construed not to be limited to such aspects of the present invention described below and technical concepts of the present invention may be implemented in combination with other known technologies or the other technology having functions equivalent to such known technologies.

Now, a method of manufacturing a crystal oriented ceramics according to a first aspect of the present invention will be described below in detail.

The manufacturing method, implementing the first aspect of the present invention, provides the crystal oriented ceramics formed in a polycrystalline body, having an isotropic perovskite-based compound as a principal phase, which has crystal grains constituting the polycrystalline body with each crystal grain oriented on a specific crystal plane A.

As used herein, the term “isotropic” refers to a structure in which when expressing a perovskite-based structure ABO₃ in terms of a pseudocubic-based lattice, relative ratios among axis lengths “a”, “b” and “c” lay in a value ranging from 0.8 to 1.2 and axis angles α, β and γ lay in a value ranging from 80 to 100°.

Examples of the isotropic perovskite-based compound include a compound expressed by a general formula (1), for instance, ABO₃ (provided that an A-site element takes a principal component composed of more than one kind selected from a group consisting of K, Na and Li and a B-site element takes a principal component composed of more than one kind selected from a group consisting of Nb, Sb and Ta).

The A-site and/or B-site, expressed by the general formula (1) described above, may contain the principal component element and, in addition thereto, additive element as a subsidiary component.

Further, the compound, expressed by the general formula (1) described above, may preferably include compounds each having a basic composition containing potassium sodium niobate expressed as (K_{1-y}Na_{y})NbO₃. These include: a compound in which a part of the A-site element (K and Na) is substituted with a given amount of Li; a compound in which a part of the B-site element (Nb) is substituted with a given amount of Ta and/or Sb; or a compound in which the part of the A-site element (K and Na) is substituted with a given amount of Li and the part of the B-site element (Nb) is substituted with the given amount of Ta and/or Sb.

Further; the isotropic perovskite-based compound may be preferably expressed by a general formula (2): {Liₓ(K_{1-y}Na_{y})₁₋ₓ}(Nb_{1-z-w}Ta_{z}Sb_{w})O₃ (provided that 0≦x≦0.2, 0≦y≦1, 0≦z≦0.4, 0≦w≦0.2 and x+z+w>0).

In this case, it becomes possible to manufacture the crystal oriented ceramics with excellent piezoelectric characteristic and dielectric characteristic or the like.

In the general formula (2), the relationship expressed as “x+z+w>0” represents that it may suffice for at least one of Li, Ta and Sb to be contained as a substitution element.

In the general formula (2), further, reference to “y” represents a ratio between K and Na contained in the isotropic perovskite-based compound. In addition, it may suffice for the compound, expressed by the general formula (2), to contain at least one of K or Na as the A-site element.

A range of gyp in the general formula (2) may preferably satisfy the relationship expressed as 0≦y≦1.

In this case, the compound, expressed by the general formula (2) described above, has Na as an essential component. This allows the crystal oriented ceramics to have further increased piezoelectric g₃₁ constant.

Further, the range of “y” in the general formula (2) may preferably satisfy the relationship expressed as 0≦y<1.

In this case, the compound, expressed by the general formula (2) described above, contains K an essential component. Therefore, this allows the crystal oriented ceramics to have further increased piezoelectric characteristic such as a piezoelectric d₃₃ constant. In this case, moreover, with an increase in an additive amount of K, the sintering can be conducted at further decreased temperatures, thereby making it possible to manufacture the crystal oriented ceramics at saved energy with low cost.

In the general formula (2), further; reference to “y” may preferably lay in the relationship expressed as 0.05≦y≦0.75 and, more preferably, 0.20≦y≦0.70. In these cases, the crystal oriented ceramics have further increased piezoelectric characteristic such as a piezoelectric d₃₃ constant and a further increased electrical solution total number Kp. In addition, more preferably, “y” may lay in the relationship expressed as 0.20≦y<0.70 and, more preferably, the relationship expressed as 0.35≦y≦0.65. More preferably, “y” may lay in the relationship expressed as 0.35≦y<0.65. Most preferably, “y” may lay in the relationship expressed as 0.42≦y≦0.60.

Reference to “x” represents an amount of Li that is substituted with K and/or Na representing the A-site element. Substituting the parts of K and/or Na by Li, the crystal oriented ceramics can obtain various advantageous effects such as an increase in piezoelectric characteristic, an increase in Curie temperature and/or an acceleration in densification.

A range of “x” in the general formula (2) may preferably satisfy the relationship expressed as 0<x≦0.2.

In this case, the compound, expressed by the general formula (2) described above, has Li as an essential component. This allows the crystal oriented ceramics to be sintered in a further easy manner during production thereof, with accompanying improvement in piezoelectric characteristic and a further increase in Curie temperature (Tc). This is because selecting Li as the essential component within the range of “x” results in a capability of causing a drop in sintering temperature while permitting Li to play a role as a sintering aids to make it possible to achieve the sintering with the occurrence of fewer voids.

If a value of “x” exceeds 0.2, a risk arises with the occurrence of a drop in piezoelectric characteristic (piezoelectric d₃₃ constant, electromechanical coupling coefficient kp, piezoelectric 931 constant or the like).

Further; the value of “x” in the general formula (2) may preferably satisfy the relationship x=0.

In this case, the general formula (2) can be rewritten as (K_{1-y}Na_{y})(Nb_{1-z-w}Ta_{z}Sb_{w})O₃, In such a case, when manufacturing the crystal oriented ceramics, the raw material for such ceramics does not contain a compound like, for instance, LiCO₃ that contains the lowest lightweight component of Li. This enables a reduction in characteristic due to segregation of a raw material powder when mixing the raw material to manufacture the crystal oriented ceramics. In such a case, further, it becomes possible to realize a high relative permittivity and a relatively large piezoelectric g constant. In the general formula (2), “x” may lay in the relationship expressed as 0≦x≦0.15 and, more preferably, 0≦x≦0.10.

Reference to “z” represents an amount of Ta that is substituted with K and/or Na representing the A-site element. Substituting the parts of K and/or Na by Ta, the crystal oriented ceramics has an advantageous effect with an increase in piezoelectric characteristic or the like. In the above formula (2), if a value of “z” exceeds 0.4, then a risk arises with the occurrence of a drop in Curie temperature with accompanying difficulty in being used as a piezoelectric material for electric appliances and motor vehicles.

In the general formula (2), a range of “z” may preferably satisfy the relationship expressed as 0<z≦0.4.

In this case, the compound, expressed by the general formula (2) described above, has Ta as an essential component. In this case, therefore, a drop occurs in sintering temperature and Ta plays a role as a sintering aids, enabling the crystal oriented ceramics to be formed in structure with less amount of voids.

Further, the value of “z” in the general formula (2) may preferably satisfy the relationship expressed as z=0.

In this case, the general formula (2) can be rewritten as {Liₓ(K_{1-y}Na_{y})₁₋ₓ}(Nb_{1-w}Sb_{w})O₃. In such a case, no Ta is contained in the compound expressed in the above formula (2). In such a case, therefore, the compound expressed in the above formula (2) can exhibit excellent piezoelectric characteristic without using expensive Ta component during the production of the crystal oriented ceramics.

In the general formula (2), the value of “z” may preferably lay in the relationship expressed as 0≦z≦0.35 and, more preferably, 0≦z≦0.30.

Reference to “w” represents an amount of Sb that is substituted with Nb representing the B-site element. Substituting the part of Nb by Sb, the crystal oriented ceramics has an advantageous effect with an increase in piezoelectric characteristic or the like. If a value of “w” exceeds 0.2, then a drop occurs in piezoelectric characteristic and/or Curie temperature with accompanying occurrence of an unacceptable result.

In the general formula (2), the value of “w” may preferably satisfy the relationship 0<w≦0.2.

In this case, the compound, expressed by the general formula (2) described above, has Sb as an essential component. In this case, therefore, a drop occurs in sintering temperature with accompanying improvement in sintering capability, enabling the crystal oriented ceramics to be formed in structure with improved stability in dielectric loss tan δ.

Further, the value of “w” in the general formula (2) may preferably satisfy the relationship expressed as w=0.

In this case, the general formula (2) can be rewritten as {Liₓ(K_{1-y}Na_{y})₁₋ₓ}(Nb_{1-z}Ta_{z})O₃. In such a case, no Sb is contained in the compound expressed in the above formula (2). In such a case, therefore, the compound expressed in the above formula (2) can exhibit a relatively high Curie temperature. In the general formula (2), the value of “w” may preferably lay in the relationship expressed as 0≦w≦0.15 and, more preferably, 0≦w≦0.10.

Further, although the crystal oriented ceramics may be preferably composed of the isotropic perovskite-based compound expressed in the above formula (2), it may suffice for the crystal oriented ceramics to contain another element or another phase provided that the isotropic perovskite-based compound is sustained with no adverse affect on various parameters such as a sintering characteristic and piezoelectric characteristic or the like.

Furthermore, the crystal oriented ceramics is composed of the polycrystalline body, constituting the crystal oriented ceramics, which have the crystal grains with each crystal grain being oriented on the specific crystal plane A.

As used herein, the expression “oriented on the specific crystal plane A” is meant by the fact that respective crystal grains are oriented under a state (hereinafter referred to as “plane orientation”) to allow the perovskite-based compound to have specific crystal planes paralleled to each other.

The kind of oriented crystal plane A may be possibly selected depending oil an orientation of intrinsic polarization of the isotropic perovskite-based compound and applications and requirement characteristic of the crystal oriented ceramics. That is, the crystal plane A may be preferably selected from a pseudocubic {100} plane, a pseadocubic {200} plane, a pseudocubic {110} plane and a pseudocubic {111} plane or the like.

Preferably, the crystal plane A may preferably include the pseudocubic {100} plane and/or the pseudocubic {200} plane.

In this case, the crystal plane A is perpendicular to a polarization axis of the perovskite-based compound and oriented in the same direction in which oriented grains are displaced, enabling a further increase in displacement performance of the crystal oriented ceramics.

As used herein, the term “pseudocubic {HKL}” is meant by the fact that the isotropic perovskite-based compound generally takes the form of a structure slightly distorted from a cubic crystal such as a tetragonal crystal, an orthorhombic crystal and a trigonal crystal, etc., and such a distortion occurs within a few range whereby the isotropic perovskite-based compound is regarded to be a cubic crystal to be displayed on Miller Indices.

With specific crystal planes A structured in plane orientation, the degree of plane orientation can be expressed in an average degree of orientation F (HKL) based on a Lotgering method expressed by the following mathematical equation (1):

$$F ( HKL ) = \frac{\frac{{Σ}^{′} I ( HKL )}{Σ I ( hkl )} - \frac{{Σ}^{′} {I}_{0} ( HKL )}{Σ {I}_{0} ( hkl )}}{1 - \frac{{Σ}^{′} {I}_{0} ( HKL )}{Σ {I}_{0} ( hkl )}} \times 100 ( \% ) \qquad [ Equation 1 ]$$

In Equation 1, ΣI (hkl) represents a total sum of the X-ray diffraction intensity of entire crystal planes (hkl) measured for a crystal oriented ceramics. ΣI₀(hkl) represents a total sum of the X-ray diffraction intensity of entire crystal planes (hkl) measured for a non-oriented piezoelectric ceramics having the same composition as that of the crystal oriented ceramics. Further, Σ′I (HKL) represents a total sum of the X-ray diffraction intensity of crystallographically equivalent specified crystal planes (HKL) measured for the crystal oriented ceramics. ΣI₀(HKL) represents the total sum of the X-ray diffraction intensity of the crystallographically equivalent specified crystal planes (HKL) measured for the non-oriented piezoelectric ceramics having the same composition as that of the crystal oriented ceramics.

Accordingly, under a circumstance where the crystal grains, forming the polycrystalline body, are formed in a non-oriented structure, an average orientation degree F (HKL) lies at 0%. Furthermore, in a case where the planes (HKL) of the crystal grains, forming the polycrystalline body, are oriented on a plane parallel to measured surfaces, the average orientation degree F (HKL) lies at 100%.

The crystal oriented ceramics glows such that the greater the proportion of the oriented crystal grains, the higher will be the characteristics.

Further, the specific crystal plane to be oriented may preferably include a plane perpendicular to a polarization axis.

The crystal oriented ceramics is composed of the polycrystalline body having the isotropic perovskite-based compound as the principal phase. Among piezoelectric ceramics of a nonleaded system, the crystal oriented ceramics can exhibit a high piezoelectric characteristic or the like. In addition, the crystal oriented ceramics has the crystal grains, forming the polycrystalline body, which have the specific crystal planes oriented in one direction. Thus, the crystal oriented ceramics has a higher piezoelectric characteristic or the like than that of the non-oriented sintered body formed in the same composition.

The ceramics composed of the isotropic perovskite-based compound, having a complicated composition like that of the compound expressed by the general formula (2), can be manufactured in a manner described below. That is, plural compounds, each having a simplified composition containing, for instance, constituent elements of a target composition, are mixed in a targeted stoichiometric ratio. The resulting mixture is then shaped into a compact that is subsequently calcined after which the calcined compact is pulverized. The resulting pulverized powder is shaped into a compact again, which is subsequently sintered. However, with such a manufacturing method, it is extremely difficult to manufacture the crystal oriented ceramics with the specific crystal plane of each crystal grain oriented in a specified direction.

According to the first aspect of the present invention, as set forth above, the anisotropically shaped powder is oriented in a compact body. Using the anisotropically shaped powder as a template or a reactive template allows the isotropic perovskite-based compound like, for instance, the compound expressed by the general formula (2) to be synthesized or sintered. This enables each crystal grain, forming the polycrystalline body, to have the specific crystal plane oriented in one direction.

The lattice consistency can be expressed in terms of a lattice consistency rate.

In explaining the lattice consistency, description will be made of a case in which the lattice grain is comprised of, for instance, metal oxide. That is, a two-dimensional crystal lattice, placed on the oriented plane of the oriented grain, has a lattice consistency between a lattice point composed of, for instance, an oxygen atom or a lattice point composed of a metallic atom and the lattice point composed of the oxygen atom or the lattice point composed of the metallic atom in a two-dimensional crystal lattice of the specific crystal plane A oriented in the polycrystalline body when both of these lattice points lay in a scaling relation.

As used herein, the term “lattice consistency” refers to a value, obtained by allowing an absolute value of a difference between the oriented plane in the oriented grains and a lattice dimension placed in a scaling position of the specific crystal plane A oriented in the polycrystalline body to be divided by the lattice dimension of the oriented plane in the oriented grain, which is expressed in percentage.

As used herein, the term “lattice dimension” refers to a distance between the lattice points in the two-dimensional crystal lattice on one crystal plane which can be measured by analyzing a crystal structure with the use of an X-ray analysis or an electron diffraction analysis or the like. In general, the oriented grain grows such that the smaller the lattice consistency rate, the higher will be the lattice consistency with respect to the crystal plane A and the oriented grain can be functioned as a favorable template.

In order to obtain a crystal oriented ceramics with a further increased orientation degree, the oriented grain may preferably have a lattice consistency of 20% or less, more preferably of 10% or less and, most preferably, 5% or less.

Further, the oriented planes may preferably have the same planes as the crystal plane A.

In such a case, the crystal oriented ceramics with the crystal plane A being oriented can be manufactured in a relatively simple manner. In particular, for the oriented grain, it becomes possible to use a grain with a pseudocubic {100} plane and/or a pseudocubic {200} plane being oriented. In this case, it becomes possible to obtain a crystal oriented ceramics with accompanying improvement in temperature dependency in displacement occurring under an increased electric field in a tetragonal region with an orientation axis and a polarization axis placed in coincidence.

As used herein, the term “anisotropic shape” refers to a profile in which a dimension in a longitudinal direction is greater than that of an axial direction or a thickness direction. More particularly, examples of such a shape may preferably include a plate-like shape, a columnar shape, a scale-like shape and a needle shape, etc. Moreover, it is possible to select a kind of the crystal plane forming the oriented plane from various crystal planes depending on a purpose to be achieved.

For the oriented grains, it may be preferable to use grains each having a shape that can be easily oriented in a certain direction during a shaping step. Therefore, the oriented grains may preferably have an average aspect ratio of 3 or more. If the average aspect ratio is less than 3, then a difficulty is encountered in permitting the anisotropically shaped powder oriented in one direction during a subsequent shaping step. In order to obtain the crystal oriented ceramics with further increased orientation degree, the oriented grains may preferably have an average aspect ratio of 5 or more. In addition, as used herein, the term “average aspect ratio” refers to an average value in a maximum dimension and/or a minimum dimension of the oriented grain.

Further, the oriented grains have a tendency varying such that the greater the average aspect ratio, the easier it will be to orient the grains during the shaping step. However, if the average aspect ratio increases in excess, then there is a risk to arise with the occurrence of breakdown in the oriented grains. As a result, a risk arises with difficulty encountered in performing the shaping step to obtain a compact with the oriented grains being oriented. Accordingly, the oriented grains may preferably have an average aspect ratio of 100 or less. More preferably, the average aspect ratio may be of 50 or less and, most preferably, of 30 or less.

Further, the oriented grains are comprised of the perovskite-based compound.

More particularly, it may be possible to use the oriented grains each having the same composition as that of a targeted isotropic perovskite-based compound like the compound expressed by the general formula (2) set forth above.

Furthermore, no need arises for the oriented grains to have the same composition as that of the targeted isotropic perovskite-based compound like the compound expressed in, for instance, the general formula (1) or the general formula (2) set forth above. That is, it may suffice for the oriented grains to form the isotropic perovskite-based compound expressed by the general formula (1) or the general formula (2) to be targeted. Consequently, the oriented grains may be selected from compounds or solid solutions containing an element of more than one kind selected from cationic elements contained in the isotropic perovskite-based compound to be manufactured.

Examples of the oriented grain, satisfying the conditions set forth above, may include a compound, such as NaNbO₃ (hereinafter referred to as “NN”), KNbO₃ (hereinafter referred to as “KN”), (K_{1-y}Na_{y})NbO₃ (0<y<1) or those in combination with such components in which given amounts of Li, Ta and/or Sb are substituted in a solid solution, which is expressed by a general formula (4):

{Liₓ(K_{1-y}Na_{y})₁₋ₓ}(Nb_{1-z-w}Ta_{z}Sb_{w})O₃ (4)

(wherein “x”, “y”, “z” and “w” satisfy the relationships expressed as 0≦x≦1, 0≦y≦1, 0≦z≦1 and 0≦w≦1).

The compound, expressed by the general formula (4), has a favorable lattice consistency with the isotropic perovskite-based compound expressed by the general formula (2) in nature. Therefore, the anisotropically shaped powder (hereinafter referred to as “anisotropically shaped powder A”) is composed of the oriented grains, expressed by the general formula (4) discussed above, which take the oriented planes each composed of a plane having a lattice consistency with the crystal plane A in the polycrystalline body, thereby functioning as a reactive template for manufacturing the crystal oriented ceramics. In addition, since the anisotropically shaped powder A is composed of the cation ion elements contained in the targeted isotropic perovskite-based compound substantially expressed by the general formula (2), it becomes possible to manufacture a crystal oriented ceramics with an extremely less amount of impurity elements.

Further, examples of the anisotropically shaped powder may include a powder, composed of, for instance, a layered perovskite-based compound, which has a lattice consistency with the crystal plane A in a polycrystalline body having a crystal plane with less surface energy composed of the compound expressed by the general formula (2). The layered perovskite-based compound has a crystal lattice with increased anisotropy, making it possible to synthesize all anisotropically shaped powder (hereinafter referred to as “anisotropically shaped powder B”), composed of a layered perovskite-based compound, which takes the form of a crystal plane with less amount of surface energy.

A first example of a layered perovskite-based compound suitable as the anisotropically shaped powder B may include a bismuth-layer-like perovskite-based compound expressed by, for instance, a general formula (5):

(Bi₂O₂)²⁺{Bi_{0.5}Me_{m-1.5}NbₘO₃ₘ₊₁}²⁻ (5)

(wherein “m” is an integer number greater than 2 and Me is an element of more than one kind selected from Li, K and Na)

The compound, expressed by the general formula (5), has a {001} plane with surface energy less than that of the other crystal plane. Therefore, using the compound, expressed by the general formula (5), enables the anisotropically shaped powder B with an oriented plane on the {001} plane to be easily synthesized. As used herein, the term “{001} plane” refers to a plane parallel to a (Bi₂O₂)²⁺ layer of the bismuth-layer-like perovskite-based compound expressed by the general formula (5). Also, the {001} plane of the compound expressed by the general formula (5) has an extremely favorable lattice consistency with respect to a pseudo {100} plane of the isotropic perovskite-based compound expressed by the general formula (2).

Therefore, the anisotropically shaped powder B, composed of the compound expressed by the general formula (5) and having the {001} plane as the oriented plane, is preferably used as a reactive template for manufacturing a crystal oriented ceramics having a pseudo {100} plane as the oriented plane. That is, the anisotropically shaped powder B is preferably used as the anisotropically shaped powder. In addition, when using the compound expressed by the general formula (5), a microscopic powder is optimized in composition in a manner as described below, thereby enabling the preparation not to substantially include Bi as the A-site element. Even by using such an anisotropically shaped powder B, it becomes possible to manufacture a crystal oriented ceramics having the isotropic perovskite-based compound, expressed by the general formula (2), as the main phase.

Furthermore, a second example of the layered perovskite-based compound suitable as material for the anisotropically shaped powder B may include, for instance, Sr₂Nb₂O₇. The compound Sr₂Nb₂O₇ has a {010} plane with surface energy less than that of other crystal planes and extremely favorable lattice consistency with respect to the pseudo {110} plane of the isotropic perovskite-based compound expressed by the general formula (2). Therefore, the anisotropically shaped powder, composed of Sr₂Nb₂O₇ and having the {010} plane formed in the oriented plane, is suitable as a reactive template for manufacturing the crystal oriented ceramics.

Moreover, a third example of the layered perovskite-based compound suitable as material for the anisotropically shaped powder B may include, for instance, Na_{1.5}Bi_{2.5}Nb₃O₁₂, Na_{2.5}Bi_{2.5}Nb₄O₁₅, Bi₃TiNbO₉, Bi₃TiTaO₉, K_{0.5}Bi_{2.5}Nb₂O₉, CaBi₂Nb₂O₉, SrBi₂Nb₂O₉, BaBi₂Nb₂O₉, BaBi₃Ti₂NbO₁₂, CaBi₂Ta₂O₉, SrBi₂Ta₂O₉, BaBi₂Ta₂O₉, Na_{0.5}Bi_{2.5}Ta₂O₉, Bi₇Ti₄NbO₂₁, Bi₅Nb₃O₁₅ or the like. These compounds have {001} planes that have favorable lattice consistency with the pseudo {100} plane of the isotropic perovskite-based compound expressed by the general formula (2). Therefore, the anisotropically shaped powder, composed of such compounds and having the {001} planes formed in oriented planes, is suitable as a reactive template for manufacturing the crystal oriented ceramics with the pseudo {100} plane in an oriented plane.

Besides, a fourth example of the layered perovskite-based compound suitable as material for the anisotropically shaped powder B may include, for instance, Ca₂Nb₂O₇, Sr₂Ta₂O₇ or the like. These compounds have {010} planes that have favorable lattice consistency with the pseudo {110} plane of the isotropic perovskite-based compound expressed by the general formula (2). Therefore, the anisotropically shaped powder, composed of such compounds and having the {010} planes formed in oriented planes, is suitable as a reactive template for manufacturing the crystal oriented ceramics with the pseudo {110} plane in an oriented plane.

Next, a method of manufacturing the anisotropically shaped powder according to the first aspect of the present invention will be described below in detail.

The anisotropically shaped powder (that is, the anisotropically shaped powder B), composed of the layered perovskite-based compound formed in a given composition with an average grain diameter and/or aspect ratio, can be easily manufactured. To this end, oxides, carbonates and nitrates inclusive of relevant constituent elements for the anisotropically shaped powder B are prepared as raw materials (hereinafter referred to as “anisotropically shaped powder yielding raw material”). This anisotropically shaped powder yielding raw material is then heated with liquid or a substance becoming liquid when heated.

With the anisotropically shaped powder yielding raw material heated in a liquid phase in which atoms are easily diffused, the anisotropically shaped powder B can be easily synthesized in a structure with a preferentially-developed plane (such as, for instance, {001}plane for the compound expressed by the general formula (5)) having less surface energy. In this case, the aspect ratio and the average grain diameter of the anisotropically shaped powder B can be controlled upon suitably selecting synthesizing conditions.

Suitable examples of the method of manufacturing the anisotropically shaped powder B may include, for instance, a flux method in which, for instance, a suitable flux (such as, for instance, NaCl, KCl, a mixture of NaCl and KCl, BaCl₂, KF or the like) is added to the anisotropically shaped powder yielding raw material and a resulting mixture is heated at given temperatures. In an alternative, a hydrothermal synthesis method is suitably employed in which an amorphous powder, having the same composition as that of the anisotropically shaped powder B to be obtained, is added to an alkaline aqueous solution after which a resulting mixture is heated in an autoclave.

Meanwhile, the compound, expressed by the general formula (4), has a crystal lattice with extremely small anisotropy and, hence, it is difficult to directly synthesize the anisotropically shaped powder (that is, the anisotropically shaped powder A) composed of the compound expressed by the general formula (4) and having a specific crystal plane placed on an oriented plane. However, the anisotropically shaped powder A can be manufactured using the anisotropically shaped powder B, set forth above, as a reactive template. To this end, this anisotropically shaped powder B and the other anisotropically shaped powder B, satisfying a given condition and described below, can be heated in a flux.

Further, when synthesizing the anisotropically shaped powder A using the anisotropically shaped powder B as the reactive template, optimizing a reacting condition results in only change in a crystal structure with almost no variation taking place in a powder shape.

For easily synthesizing the anisotropically shaped powder A that can be easily oriented in one direction during the shaping step, the anisotropically shaped powder B used for such a synthesis may preferably have a shape to be easily oriented in one direction during the shaping step.

That is, even when synthesizing the anisotropically shaped powder A using the anisotropically shaped powder B as the reactive template, the average aspect ratio of the anisotropically shaped powder A may preferably be of at least 3 or more and, more preferably, of 5 or more and, most preferably, of 10 or more. In addition, for minimizing the occurrence of comminution in a subsequent step, the average aspect ratio may preferably be of 100 or less.

As used herein, the term “reactive raw material B” refers to a material for creating the anisotropically shaped powder A composed of the compound expressed by the general formula (4). In this case, the reactive material B may be of the type available to create only the compound expressed by the general formula (4) when reacted with the anisotropically shaped powder B or of the type available to create both the compound, expressed by the general formula (4), and a surplus constituent. As used herein, the term “surplus constituent” refers to a substance except for the targeted compound expressed by the general formula (4). Moreover, when producing the surplus constituent with the anisotropically shaped powder A and the reactive material B, the surplus constituent may be preferably composed of a substance that can be thermally and chemically removed in an easy fashion.

The reactive material B may be used in various modes like salts such as, for instance, an oxide powder; a carbonate powder, a nitrate powder and oxalate, and alkoxide or the like. In addition, the reactive material B may have a composition that can be determined with a composition of the compound, expressed by the general formula (4), and a composition of the anisotropically shaped powder B.

For instance, the anisotropically shaped powder B may be used in a composition of Bi_{2.5}Na_{0.5}Nb₂O₉ (hereinafter referred to as “BINN2”) representing one kind of the bismuth-layer-like perovskite-based compound expressed by the general formula (5). When using the anisotropically shaped powder B for synthesizing the anisotropically shaped powder A composed of NaNbO₃ (NN) representing one kind of the compound expressed by the general formula (4), it becomes possible to use compounds (such as oxides, hydroxides, carbonates, nitrates or the like) containing Na as the reactive material B.

1 wt % to 500 wt % of suitable flux (such as, for instance, NaCl, KCl, a mixture of NaCl and KCl, BaCl₂, Kr or the like) is added to the anisotropically shaped powder B, forming such a composition, and the reactive material B. The resulting mixture is then heated at a eutectic point and a melting point, thereby producing a surplus constituent having a principal component of NN and Bi₂O₃. Bi₂O₃ has a low melting point and is dissolved by acid and, therefore, flux is removed from the resulting reactant by hot-water washing or the like. Thereafter, the resulting reactant is heated at high temperatures or subjected to acid cleaning. This makes it possible to obtain the anisotropically shaped powder A composed of NN with a {100} plane on an oriented plane.

Further, using the anisotropically shaped powder B allows the anisotropically shaped powder A to be synthesized in a composition of, for instance, BINN2 and composed of (K_{0.5}Na_{0.5})NbO₃ (hereinafter referred to as “KNN”) representing one kind of the compound expressed by the general formula (4). In such a case, it may suffice to use the reactive material B such as a compound (such as oxides, hydroxides, carbonates, nitrates or the like), containing Na, and a compound (such as oxides, hydroxides, carbonates, nitrates or the like), containing K, or a compound containing both of Na and K.

1 wt % to 500 wt % of suitable flux is added to the anisotropically shaped powder B, having such a composition, and the reactive material B. The resulting mixture is then heated at a eutectic point and a melting point, thereby producing a surplus constituent having a principal component of KNN and Bi₂O₃. Removing flux and Bi₂O₃ from the resulting reactant results in a capability of obtaining the anisotropically shaped powder A composed of KNN with a {110} plane on an oriented plane.

When producing the compound, expressed by the general formula (4), by reacting the anisotropically shaped powder B and the reactive material B with each other, it may suffice to similarly heat the anisotropically shaped powder B, having a given composition, and the reactive material B, having a given composition, in a suitable flux. This results in a capability of producing the compound with a target composition, expressed by the general formula (4), in flux. In addition, removing flux from the resulting reactant enables the anisotropically shaped powder A to be obtained in a composition expressed by the general formula (4) and having a specific crystal plane on an oriented plane.

The compound with a target composition, expressed by the general formula (4), as has the crystal lattice with small anisotropy as described above with difficulty being countered in directly synthesizing the anisotropically shaped powder A. Further, it is also difficult to directly synthesize the anisotropically shaped powder A with an arbitrary crystal plane on an oriented plane.

On the contrary, the layered perovskite-based compound has a crystal lattice with large anisotropy and, hence, it becomes easy to directly synthesize the anisotropically shaped powder. Further, an oriented plane of the anisotropically shaped powder, composed of such a layered perovskite-based compound, often has lattice consistency with the specific crystal plane of the compound expressed by the general formula (4). Furthermore, the compound, expressed by the general formula (4), is thermally more stable than that of the layered perovskite-based compound.

Therefore, upon reacting the anisotropically shaped powder B, composed of the layered perovskite-based compound and having lattice consistency with the specific crystal plane of the compound expressed by the general formula (4), and the reactive raw material B in a suitable flux, the anisotropically shaped powder B can function as a reactive template. This results in a capability of easily synthesizing the anisotropically shaped powder A, composed of the compound expressed by the general formula (4), in a structure inheriting an orientation aspect of the anisotropically shaped powder B.

Further, with the optimization in compositions of the anisotropically shaped powder B and the reactive raw material B, the extra A-site element (hereinafter referred to as “surplus A-site element”), contained in the anisotropically shaped powder B, is expelled as a surplus constituent. In addition, the anisotropically shaped powder A is produced in a compound expressed by the general formula (4) in the absence of the surplus A-site element.

Particularly, when permitting the anisotropically shaped powder B to be composed of the layered perovskite-based compound expressed by the general formula (5), the surplus constituent is obtained in a principal component of Bi₂O₃ with Bi discharged as the surplus A-site element. Therefore, upon thermally or chemically removing such a surplus component, the anisotropically shaped powder A can be obtained in the compound, expressed by the general formula (4), which does not substantially contain Bi and has the specific crystal plane on the oriented plane.

The oriented grains may preferably include an isotropic perovskite-based compound expressed by a general formula (3) of ABO₃ wherein an A-site element has a principal component composed of at least one kind selected from the group consisting of K, Na and Li and a B-site element has a principal component composed of at least one kind selected from the group consisting of Nb, Sb and Ta.

In this case, using such oriented grains allows the production of a crystal oriented ceramics of an isotropic perovskite-based potassium sodium niobate exhibiting relatively higher piezoelectric characteristic than that of a compound of a non-lead system.

More preferably, the oriented grains may be composed of a compound expressed by the general formula (4).

In this case, the crystal oriented ceramics can be produced having a higher degree of orientation.

That is, as set forth above, the compound expressed by the general formula (4) has favorable lattice consistency with the compound expressed by the general formula (2). Therefore, the anisotropically shaped powder, composed of the oriented grains expressed by the general formula (4) and having the specific crystal plane on the oriented plane, can function as a favorable reactive template for producing the crystal oriented ceramics.

Next, the microscopic powder has one-third or less of a grain diameter of the anisotropically shaped powder.

If the grain diameter of the microscopic powder exceeds one-third that of the grain diameter of the anisotropically shaped powder, there is a risk with the occurrence of difficulty of forming the raw material mixture so as to allow the anisotropically shaped powder to have the oriented planes oriented in a nearly identical direction. More preferably, the grain diameter of the microscopic powder may be one-fourth or less that of the grain diameter of the anisotropically shaped powder and, most preferably, one-fifth or less that of the grain diameter of the anisotropically shaped powder.

The comparison in grain diameter between the microscopic powder and the anisotropically shaped powder can be conducted by making a comparison between an average diameter of the microscopic powder and an average diameter of the anisotropically shaped powder. In addition, the grain diameters of the microscopic powder and the anisotropically shaped powder refer to diameters the longest axes, respectively.

The composition of the microscopic powder can be determined in accordance with a composition of the anisotropically shaped powder or a composition of the isotropic perovskite-based compound expressed by, for instance, the general formula (1) or the general formula (2). Further, examples of the microscopic powder may include, for instance, an oxide powder, a composite oxide powder, a hydroxide powder, salts of carbonate, nitrate and oxalate, or alkoxide or the like.

Examples of the microscopic powder may include those that react with the anisotropically shaped powder when sintered therewith to produce a targeted isotropic perovskite-based compound expressed by, for instance, the general formula (1) or the general formula (2).

Further, the anisotropically shaped powder and the microscopic powder may preferably have compositions different from each other that allow a chemical reaction between the anisotropically shaped powder and the microscopic powder during the sintering step for producing the isotropic perovskite-based compound.

Furthermore, the microscopic powder may be of the type that reacts with the anisotropically shaped powder for producing only the targeted isotropic perovskite-based compound or of the type that produces both of the targeted isotropic perovskite-based compound and a surplus component. If the surplus component is produced upon the reaction between the anisotropically shaped powder and the microscopic powder, it is preferable for the surplus component to be thermally or chemically removed in an easy fashion.

Next, in the mixing step, the anisotropically shaped powder and the microscopic powder are mixed to each other to prepare a raw material mixture.

In the mixing step, an amorphous fine powder (hereinafter referred to as “compound fine powder”), composed of a compound made of the same composition as that of the isotropic perovskite-based compound obtained in reaction between the anisotropically shaped powder and the microscopic powder, may be added to the anisotropically shaped powder and the microscopic powder. In addition, a sintering aid such as, for instance, CuO or the like may be added to the anisotropically shaped powder and the microscopic powder Adding the compound fine powder or the sintering aids to the substances mentioned above provides an advantageous effect of easily accelerating the densification of a sintered body.

Moreover, when blending the compound fine powder, if a blending ratio of the anisotropically shaped powder increases in excess, then a blending ratio of the anisotropically shaped powder occupied in a whole of the raw material inherently decreases with an accompanying drop in an orientation degree of a specific crystal plane. Accordingly, the compound fine powder may preferably have an optimized blending ratio that is selected depending on a required density and an orientation degree of the sintered body.

In producing the isotropic perovskite-based compound expressed by the general formula (1), the anisotropically shaped powder may preferably have a blending ratio to allow one or plural constituent elements of the anisotropically shaped powder to cause the A-site of the general formula (1) to be occupied at a ratio ranging from 0.01 to 70 at % and, more preferably, at a ratio ranging from 0.1 to 50 at % and, most preferably, at a ratio ranging from 1 to 10 at %. As used herein, the term “at %” refers to a proportion of the number of atoms expressed in percentage.

Further, the raw material mixture may preferably contain additive element of more than one kind selected from metallic elements belonging to Groups 2 to 15 in a Periodic Table, semi-metal elements, transition metal elements, noble metal elements and alkaline-earth metals.

In this case, it becomes possible to manufacture the crystal oriented ceramics composed of the polycrystalline body containing the additive element. This enables improvement in piezoelectric characteristics such as a piezoelectric d₃₃ constant, an electromechanical coupling coefficient Kp and a piezoelectric g₃₁ constant or the like, and dielectric characteristics such as a relative permittivity and a dielectric loss or the like. Although the additive element may be added to the A-site and B-site of the compound expressed by the general formula (1) in substitution, the additive element may also be externally added to such a compound expressed by the general formula (1) to be present in grains thereof or on grain boundaries thereof.

Examples of a concrete method of permitting the raw material mixture to contain the additive element may include, for instance, various methods as described below.

That is, the additive element may be preferably added when synthesizing the anisotropically shaped powder during the preparing step.

Further, the additive element may be preferably added when synthesizing the microscopic powder during the preparing step.

Furthermore, the additive element may be preferably added to the microscopic powder and the anisotropically shaped powder during the mixing thereof.

By adding the additive element in such methods, the raw material mixture can be simply obtained in a composition containing the additive element. With the raw material mixture shaped and sintered, the crystal oriented ceramics can be obtained in a structure including a polycrystalline body containing the additive element.

In particular, examples of the additive element may include, for instance, Mg, Ca, Sr, Ba, Sc, Ti, V, Cr, Mn, Fe, Co, Ni, Cu, Zn, X, Zr, Mo, Hf, W, Re, Pd, Ag, Ru, Rh, Pt, Au, Ir, Os, B, Al, Ga, In, Si, Ge, Sn and B, etc.

Further, the additive element may be added in simple substances or may be added as oxides or compounds containing the additive element.

Moreover, the additive element may be preferably added to 1 mol of the isotropic perovskite-based compound expressed by the general formula (1), obtained in the sintering step, in a proportion ranging from 0.0001 to 0.15 mol.

If the additive element is less than 0.0001 mol, there is a risk to occur with difficulty of adequately causing the additive element to exhibit improving effects on the piezoelectric characteristics or the like. On the contrary, if the additive element exceeds 0.15 mol, there is another risk to occur with a drop in the piezoelectric characteristics and the dielectric characteristics of the crystal oriented ceramics.

In the mixing step, further, a mixing ratio of the additive element may be preferably adjusted to allow the additive element to be added in substitution to an element of more than one kind of any one of an A-site element and/or a B-site element of the isotropic perovskite-based compound in the sintering step at a ratio ranging from 0.01 to 15 at %.

In this case, it becomes possible to obtain the crystal oriented ceramics with the additive element added in substitution to the isotropic perovskite-based compound. Such a crystal oriented ceramics can exhibit further increased piezoelectric characteristics such as the piezoelectric d₃₃ and the electromechanical mechanical coupling constant Kp and further increased dielectric characteristics such as relative permittivity ε_{33T}/ε₀.

If the additive element is less than 0.01 at %, there is a risk to occur with difficulty of adequately obtaining improving effects of the piezoelectric characteristics and the dielectric characteristic of the crystal oriented ceramics. In contrast, if the additive element exceeds 15 at %, another risk arises with the occurrence of drops in the piezoelectric characteristics and the dielectric characteristics. More preferably, the ratio of the additive element to be mixed may lay in a value ranging from 0.01 to 5 at % and, more preferably, 0.01 to 2 at % and, most preferably, 0.05 to 2 at %.

As used herein, the term “at %” refers to a proportion of the number of substituted atoms expressed in percentage against the number of atoms of Li, K, Na, Nb, Ta and Sb in the compound expressed by the general formula (1).

In the mixing step, the anisotropically shaped powder, the microscopic powder and the compound fine powder and the sintering aids to be blended depending on needs may be mixed in a dry state or in a wet state upon adding suitable dispersant such as water, alcohol or the like. When this takes place, other elements of more than one kind selected from a binder, a plasticizer and a dispersant or the like may be added depending on needs.

Next, the shaping step will be described below.

The shaping step represents a step of shaping the raw material mixture into a compact so as to allow the anisotropically shaped powder to have the oriented planes oriented in the nearly identical direction.

Examples of the shaping method may suffice to include a method that enables the anisotropically shaped powder to be oriented.

Examples of the shaping method to cause the anisotropically shaped powder to have a plane orientation may include, for instance, a doctor-blade method, a press-forming method and press-rolling method or the like.

For increasing a thickness of or increasing an orientation degree of the compact (hereinafter suitably referred to as “plane-oriented compact”) with the anisotropically shaped powder having the plane orientation, the plane-oriented compact may be subjected to additional treatments (hereinafter referred to as “plane-orienting treatments”) such as stacking with pressure bonding, pressing and press-rolling or the like.

In this case, although the plane-orienting treatment of any one kind may be conducted on the plane-oriented compact, it may be also possible to conduct the plane-orienting treatments of greater than two kinds. Further, the plane-orienting treatment of one kind may be repeatedly conducted on the plane-oriented compact and, furthermore, the plane-orienting treatments of greater than two kinds may also be repeatedly conducted plural times, respectively.

In the shaping step, further, the compact may be preferably shaped in a tape configuration with a thickness of 30 μm or more with front and rear surfaces having compact orientation degrees with a difference falling in a value of 10% or less.

If the thickness is less than 30 μm, there is a risk to occur with the occurrence in which it is extremely difficult to handle the compact during the fabrication thereof. Further, if the difference in orientation degrees exceeds 10%, then a risk arises with the occurrence of difficulty of obtaining favorable characteristics due to resulting increased variation in orientation degree of an internal area of the crystal oriented ceramics obtained after the sintering step. More preferably, the compact orientation degree may have the difference of 5% or less and, further preferably, 3% or less.

In the evaluation step, furthermore, an orientation degree of the plane orientation of the oriented grain in the compact is measured on a Lotgering method with a full width at half maximum (FWAM) based on a rocking curve method being measured. Thus, the compact with the orientation degree of 80% or more and the full width at half maximum (FWHM) of 15° or less is selected.

If the orientation degree of the compact is 80% or more or the compact has the full width at half maximum exceeds 15°, there is a risk with the occurrence of a rapid is drop in plane orientation of the crystal oriented ceramics obtained in the sintering step. In contrast, if the compact has the orientation degree of 80% or more and the full width at half maximum exceeding 15°, the crystal oriented ceramics can be obtained in structure with increased orientation degree.

The orientation degree of the compact may be expressed in an average orientation degree F (HKL) based on the Lotgering method expressed by the Equation 1 like the orientation degree of the crystal oriented ceramics.

In Equation 1, however, ΣI (hkl) represents a total sum of the X-ray diffraction intensity of entire crystal planes (hkl) measured on the oriented grain in the compact. ΣI₀ (hkl) represents a total sum of the X-ray diffraction intensity of entire crystal planes (hkl) measured on the microscopic powder with the respective grains having crystal axes aggregated in a random state. Further, Σ′I (HKL) represents a total sum of the X-ray diffraction intensity of crystallographically equivalent specified crystal planes (HKL) measured on the oriented grain. Σ″I₀(HKL) represents the total sum of the X-ray diffraction intensity of the crystallographically equivalent specified crystal planes (HKL) measured on the microscopic powder having the same composition as that of the oriented grain in an isotropically formed shape with the respective grains having crystal axes aggregated in a random state.

Further, the full width at half maximum of the compact can be obtained in the rocking curve method. That is, an X-ray diffraction measurement is conducted with an angle θ fixed at the specific oriented plane of the oriented grain in the compact. Then, a peak width of intensity with a half of the maximum intensity on the resulting X-ray diffraction pattern (in an angular wave) is obtained and set to the full width at half maximum.

Now, the sintering step will be described below.

The sintering step represents a step of heating the compact for sintering the anisotropically shaped powder and the microscopic powder. In the sintering step, the compact is heated with a progress in sintering, thereby producing a crystal oriented ceramics formed in a polycrystalline body having an isotropic perovskite-based compound in a principal phase. When this takes place, reacting the anisotropically shaped powder and the microscopic powder results in the production of the isotropic perovskite-based compound expressed by the general formula (1) or (2). In the sintering step, moreover, a surplus component is concurrently produced depending on compositions of the anisotropically shaped powder and/or the microscopic powder.

The sintering step is carried out at an optimum heating temperature selected in accordance with the compositions of the anisotropically shaped powder and the microscopic powder in use and the composition of the crystal oriented ceramics to be manufactured. This allows the reaction and/or the sintering to be progressed at high efficiency while growing a reactant with a composition to be targeted.

In manufacturing the crystal oriented ceramics composed of the compound expressed by the general formula (2) upon using the anisotropically shaped powder A having the composition KNN as the anisotropically shaped powder, the sintering step can be conducted at heating temperatures ranging from 900° C. to 1300° C. Among values of such a temperature range, a further optimum temperature may be determined depending on the composition of the compound expressed by the general formula (2) representing a target substance. In addition, optimum time for the heating may be selected depending on the heating temperature so as to obtain a desired sintering density.

Further, in a case where the surplus component is produced due to reaction between the anisotropically shaped powder and the microscopic powder, the surplus component may remain in a sintered body as a sub phase. Moreover, the surplus component may be removed from the sintered body. In removing the surplus component from the sintered body, various methods may be taken including, for instance, the thermally removing method or the chemically removing method as set forth above.

Examples of the thermally removing method may include a method in which, for instance, a sintered body (hereinafter referred to as “an intermediate sintered body”) with the compound, expressed by the general formula (2), and the surplus component being produced is heated at a given temperature to volatilize the surplus component.

More particularly, examples of a suitable method include a method of heating the intermediate sintered body at a temperature causing volatilization of the surplus component for a long period of time under a reduced pressure or an oxygen environment.

For the heating temperature for the surplus component to be thermally removed, an optimum temperature may be selected depending on the compositions of the compound, expressed by the general formula (2), and the surplus component so as to accelerate the volatilization of the surplus component at increased efficiency while minimizing the formation of a by-product. With the surplus component formed with, for instance, a single-phase bismuth oxide, the heating temperature may preferably lay in a range from 800° C. to 1300° C. and, more preferably, in a range from 1000° C. to 1200° C.

Further, examples of the chemically removing method may include a method of immersing the intermediate sintered body in treatment liquid with property of dissolving only, for instance, the surplus component which in turn is extracted. When this takes place, treatment liquid to be used may include optimum liquid selected depending on the compositions of the compound, expressed by the general formula (2), and the surplus component. For the surplus component formed with the single-phase bismuth oxide, examples of such treatment liquid may include, for instance, acids such as nitric acid and hydrochloric acid or the like. Especially, nitric acid is suitable as treatment liquid for chemically extracting the surplus component containing bismuth oxide as a principal constituent.

The reaction between the anisotropically shaped powder and the microscopic powder and the removal of the surplus component may be conducted at any timing among concurrent timing, sequential timing and discrete timing. For instance, when directly heating the compact under a reduced pressure or an evacuated environment to a temperature at which both of the reaction between the anisotropically shaped powder and the microscopic powder and the volatilization of the surplus component are progressed at high efficiencies for thereby removing the surplus component concurrent with the reaction. In addition, during the reaction between the anisotropically shaped powder and the microscopic powder, the surplus component may be substituted to the compound expressed by the general formula (2) and representing a target substance or may be placed in the crystal grains and/or the grain boundaries as set forth above.

In another alternative, the surplus component may be removed upon heating the compact under, for instance, an atmospheric or oxygen atmosphere at a temperature causing the reaction between the anisotropically shaped powder and the microscopic powder to be efficiently accelerated to form the intermediate sintered body after which in succeeding step, the intermediate sintered body is heated under the atmospheric or oxygen atmosphere at a temperature efficiently accelerating the volatilization of the surplus component to be removed. In addition, after the intermediate sintered body is produced, the intermediate sintered body may be continuously heated under the atmospheric or oxygen atmosphere at a temperature causing the volatilization of the surplus component at high efficiency for a long period of time for thereby removing the surplus component.

Furthermore, for instance, the intermediate sintered body may be produced and cooled up to a room temperature, after which the intermediate sintered body is immersed in treatment liquid to chemically remove the surplus component. In another alternative, the intermediate sintered body may be produced and cooled up to the room temperature after which the intermediate sintered body is heated at a given temperature under a given atmosphere for thereby thermally removing the surplus component.

In a case where the compact, obtained in the shaping step, contains a resin component such as a binder heat treatment may be conducted with a view to achieving a main object of degreasing before the sintering step is conducted. In such a case, a degreasing temperature may be set to a temperature adequate for thermally decomposing at least the binder or the like. However, in another case where all easy-to-volatilize substance (such as, for instance, Na compound or the like) is contained in a raw material mixture, the degreasing may be preferably conducted at temperatures of 500° C. or less.

During the degreasing of the compact, further, the orientation degree of the anisotropically shaped powder forming the compact often decreases or a cubical expansion occurs in the compact. In such a case, after conducting the degreasing, a cold isostatic pressing (CIP) treatment may be preferably conducted on the compact before the heat treating treatment is conducted. This enables a reduction in the orientation degree caused by the degreasing or a decrease in a sintering density resulting from cubical expansion of the compact.

Further, under a circumstance where the surplus component is produced due to the reaction between the anisotropically shaped powder and the microscopic powder, when removing the surplus component, the cold isostatic pressing treatment may be conducted on the intermediate sintered body from which the surplus component is removed, after which the intermediate sintered body may be sintered again. Moreover, for increasing density and orientation degree of the sintered body, a hot press treatment may be further conducted on the sintered body subsequent to the heat treatment. In addition, the method of adding the compound fine powder and other methods of the CIP treatment and the hot press treatment or the like may be combined in use.

According to the manufacturing method of the present invention, the anisotropically shaped powder A, composed of the compound expressed by the general formula (4), can be synthesized using the anisotropically shaped powder B, composed of the layered perovskite-based compound available to be easily synthesized, as the reactive template. Then, the crystal oriented ceramics can be manufactured using the anisotropically shaped powder A as the reactive templates III this case, even if the compound, expressed by the general formula (2), has the crystal lattice with small anisotropy, the crystal oriented ceramics with arbitrary crystal plane being oriented can be manufactured at low cost in an easy fashion.

Also, by optimizing the compositions of the anisotropically shaped powder and the reactive raw material B, the crystal oriented ceramics can be synthesized even with the anisotropically shaped powder A that does not contain a surplus A-site element. Therefore, a composition control of the A-site element can be easily conducted, enabling the production of the crystal oriented ceramics formed in the principal phase having the compound expressed by the general formula (2) of a composition that cannot be obtained in a method of the related art.

Further, examples of the anisotropically shaped powder may include the anisotropically shaped powder B composed of the layered perovskite-based compound. In this case, during the sintering step, the compound, expressed by the general formula (2), can be synthesized when sintered. In addition, optimizing the compositions of the anisotropically shaped powder B and the reactive raw material to be oriented in the compact enables a target compound, expressed by the general formula (2), to be synthesized, while exhausting the A-site element in excess from the anisotropically shaped powder B as the surplus component.

Furthermore, when using the anisotropically shaped powder B, generating the surplus component that can be easy to be thermally or chemically removed, as the anisotropically shaped powder set forth above, a crystal oriented ceramics can be obtained in a structure with a specific crystal plane being oriented. That is, the crystal oriented ceramics is composed of the compound, expressed by the general formula (2), and does not substantially have the surplus A-site element.

### Example 1

Next, an example 1 of the first aspect of the present invention will be described below.

With the present example 1, a crystal oriented ceramics was manufactured in a composition formed in a polycrystalline body, containing an isotropic perovskite-based compound formed in a principal phase, which was constituted with crystal grains with a specific crystal plane ({100} plane) being oriented.

In the present example 1, the crystal oriented ceramics was manufactured in the composition in which 0.0005 mol of Mn was externally added to 1 mol of {Li_{0.065}(K_{0.45}Na_{0.55})_{0.935}}{Nb_{0.83}Ta_{0.09}Sb_{0.08})O₃.

In manufacturing the crystal oriented ceramics of the present example 2, the preparing step, the mixing step, the shaping step and the sintering step were conducted.

In the preparing step, the anisotropically shaped powder and the microscopic powder were prepared. The anisotropically shaped powder was composed of the anisotropically shaped oriented grains composed of the isotropic perovskite-based compound in which the oriented planes were formed with the crystal planes oriented so as to have lattice consistency with the specific crystal plane A. The microscopic powder had an average grain diameter of one-third or less that of the anisotropically shaped powder to produce the isotropic perovskite-based compound when sintered with the anisotropically shaped powder.

In the mixing step, the anisotropically shaped powder and the microscopic powder were mixed to each other, thereby preparing a raw material mixture.

In the shaping step, the raw material mixture was shaped, thereby preparing a compact having the oriented grains with the oriented planes oriented in a nearly identical direction.

In the evaluating step, the orientation degrees of the oriented planes of the oriented grains in the compact were measured according to the Lotgering method with the full width at half maximum (FWHM) being measured according to the rocking curve method. Thereafter, the compact with the orientation degree of 80% or more and the full width at half maximum (FWHM) of 15° or less was selected.

In the sintering step, the compact was heated to cause the anisotropically shaped powder and the microscopic powder to be sintered, thereby obtaining the crystal oriented ceramics.

Hereunder, the method of manufacturing the crystal oriented ceramics will be described below in detail.

(1) Preparation of Anisotropically Shaped Powder

First, a plate-like powder was synthesized in a composition composed of NaNbO₃ as an anisotropically shaped powder in a manner described below.

That is, a powder of Bi₂O₃, a powder of Na₂CO₃ and a powder of Nb₂O₅ were weighed to achieve a composition of Bi_{2.5}Na_{3.5}Nb₅O₁₈, upon which these powders were subjected to wet blending. Then, 50 wt % of NaCl was added as flux to the resulting raw material for dry blending for one hour. Next, the resulting mixture was put in a platinum crucible and heated under a condition at a temperature of 850° C. for one hour. Flux was completely soluble and, thereafter, the resulting mixture was heated under a condition at a temperature of 1100° C. for two hours, thereby synthesizing Bi_{2.5}Na_{3.5}Nb₅O₁₈. Also, a temperature-increasing rate was set to 200° C./hr with the temperature lowered in a furnace cooling. After cooling, hot-water washing was carried out to remove flux from a reactant, thereby obtaining a powder (anisotropically shaped powder B) of Bi_{2.5}Na_{3.5}Nb₅O₁₈. The resulting powder of Bi_{2.5}Na_{3.5}Nb₅O₁₈ was a plate-like powder with an oriented plane (maximum plane) placed on a {001} plane.

Next, a powder of Na₂CO₃ (reactive material), required for NaNbO₃ to be synthesized, was added to the powder of Bi_{2.5}Na_{3.5}Nb₅O₁₈ for mixing. NaCl was added as flux to the resulting mixture and the resulting raw material was put into the platinum crucible for heat treatment at a temperature of 950° C. for eight hours. Since the resulting reactant contained the powder of Bi₂O₃ in addition to the powder of NaNbO₃, flux was removed from the reactant and the resulting reactant was placed in HNO₃(1N) for dissolving Bi₂O₃ formed as a surplus component. Further, this solution was filtered to separate a powder (NaNbO₃ powder) composed of NaNbO₃, which in turn was washed at a temperature of 80° C. using ion-exchange water. In such a way, NaNbO₃ powder was obtained as an anisotropically shaped powder (in preparing step).

The resulting NaNbO₃ powder was a plate-like powder, having a pseudocubic {100} plane placed on a maximum plane (oriented plane) with all average grain diameter (in an average of maximum diameters) of 15 μm, which has an aspect ratio in the order of approximately 10 to 20.

(2) Preparation of Microscopic Powder

Na₂CO₃ powder, K₂CO₃ powder, Li₂CO₃ powder, Nb₂O₅ powder, Ta₂O₅ powder, Sb₂O₅ powder and MnO₂ powder, each of which has a purity of 99.99% or more, were weighed in a composition in which 0.05 mol of NaNbO₃ was subtracted from 1 mol of a stoichiometric composition of {{Li_{0.065}(K_{0.45}Na_{0.55})_{0.935}}{Nb_{0.83}Ta_{0.09}Sb_{0.08})O₃+0.0005 mol of Mn}. The resulting blend was subjected to wet blending using an organic solvent as media in a ZrO₂ ball for 20 hours. Thereafter, the resulting mixture was calcined at a temperature of 750° C. for 5 hours, after which the resulting substance was further subjected to wet blending using the organic solvent as media in the ZrO2 ball for 20 hours, thereby obtaining a calcined powder (microscopic powder) with an average grain diameter of approximately 0.5 μm (in preparing step).

(3) Preparation of Crystal Oriented Ceramics

The microscopic powder, prepared in such a way discussed above, was weighed and subjected to wet blending using the organic solvent as media in the ZrO2 ball for 20 hours. Thereafter, the anisotropically shaped powder was added to the microscopic powder in a blending ratio such that a target ceramic composition had an amount of Na (A-site element) among which 5 at % of Na was supplied from the anisotropically shaped powder. In addition, 10 parts by weight of polyvinyl butyral (PVB) resin as a binder and 5 parts by weight of butyl phthalate as a plasticizer were added to 100 parts by weight of a mixture of the anisotropically shaped powder and the microscopic powder, upon which the resulting blend was mixed for 1 hour using a mixer to obtain a raw material mixture slurry (in mixing step).

Next, the mixture slurry was shaped in a tape-like configuration with a thickness of 100 μm using a doctor blade device, thereby obtaining a compact (in shaping step). The compact contained the anisotropically shaped powder composed of plate-like oriented grains oriented in a nearly identical direction.

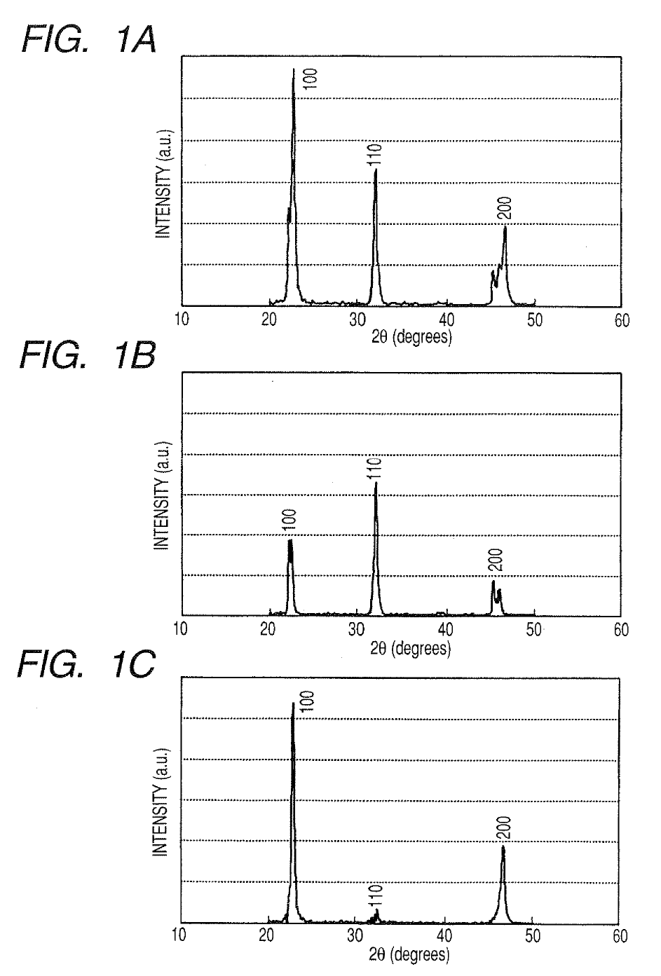

Subsequently, an average orientation degree F. of the {100} plane was obtained on a plane parallel to a tape surface of the compact upon using the Lotgering method (in evaluating step). In measuring the average orientation degree, an X-ray diffraction device (Type: RINT-TTR, manufactured by Rigaku Corporation, measured by; CuKα radiation at 50 kV/300 mA) was used, thereby measuring an X-ray diffraction intensity in an arbitrary angle ranging from 0 to 180′ (i.e. ranging from 20° to 50° in the present example) by an X-ray diffraction (2θ) method. Using such a result allowed a calculation to be made on the average orientation degree F. by referring to Equation 1 mentioned above. The compact had an X-ray diffraction pattern, which as shown in FIG. 1A.

As will be apparent from FIG. 1A, with the X-ray diffraction pattern of the compact manufactured in the present example, although almost no variation is present in peak of the {110} plane in contrast to that in an X-ray diffraction pattern of a compact with a non-orientation structure described below, a marked change occurs in peak derived from the {100} plane of the oriented grain of the anisotropically shaped powder. Accordingly, it is understood that the {100} plane is oriented.

Further, the compact with the non-orientation structure was manufactured in a manner as described below for use in the Lotgering method to calculate the average orientation degree F.

First, Na₂CO₃ powder, K₂CO₃ powder, Li₂CO₃ powder, Nb₂O₅ powder, Ta₂O₅ powder, Sb₂O₅ powder and MnCO₂ powder were weighed in a composition of {{Li_{0.065}(K_{0.45}Na_{0.55})_{0.935}}{Nb_{0.83}Ta_{0.09}Sb_{0.08})O₃+0.0005 mol of Mn}. The resulting blend was subjected to wet blending using the organic solvent as media in a ZrO2 ball for 20 hours. Thereafter, the resulting mixture was calcined at a temperature of 750° C. for 5 hours, after which the resulting substance was further subjected to wet blending using the organic solvent as media in the ZrO₂ ball for 20 hours, thereby obtaining a calcined powder with an average grain diameter of approximately 0.5 μm. Further, 10 parts by weight of polyvinyl butyral (PVB) resin as a binder and 5 parts by weight of dibutyl phthalate as a plasticizer were added to a total sum of 100 parts by weight of respective powders (microscopic powders) in the organic solvent as media, upon which the resulting blend was subjected to wet blending in the ZrO₂ ball for 20 hours, thereby obtaining a raw material mixture slurry.

Next, the mixture slurry was shaped in a tape-like configuration with a thickness of 100 μm using the doctor blade device, thereby obtaining the compact with non-orientation structure (non-oriented compact).

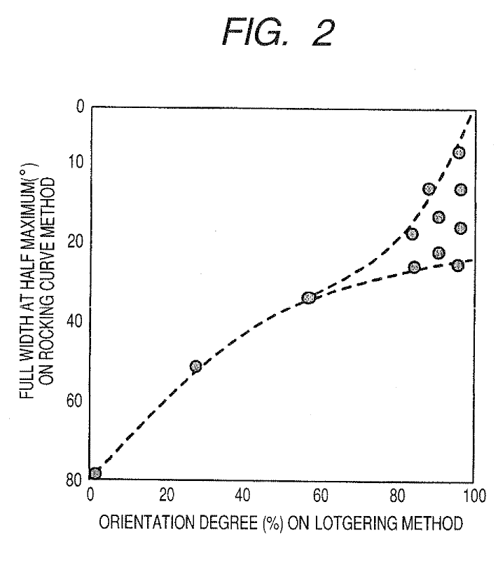

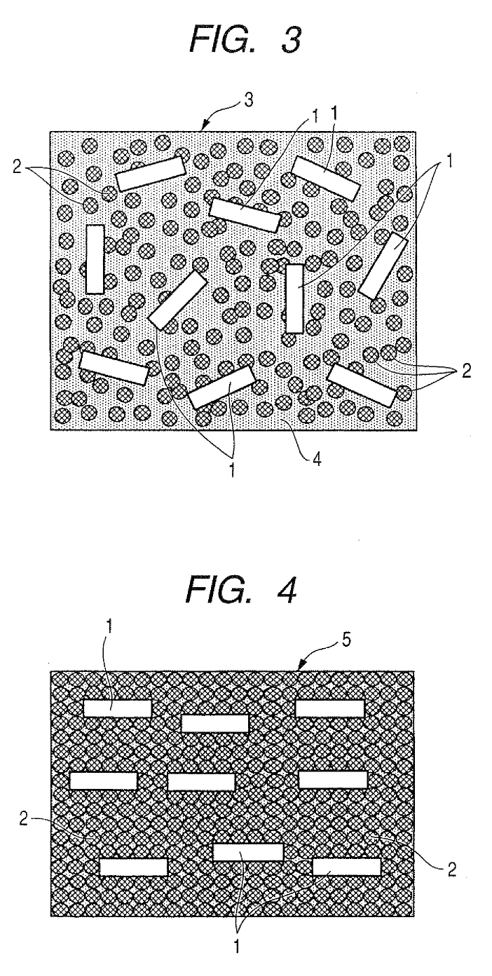

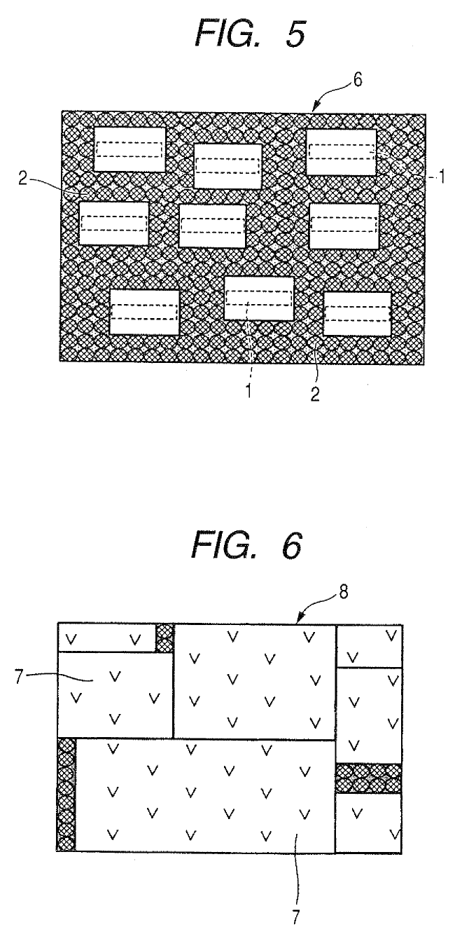

An X-ray diffraction pattern of the non-oriented compact is shown in FIG. 1B. As will be apparent from FIG. 1B, with the X-ray diffraction pattern of the non-oriented compact, only the microscopic powder exhibits a non-oriented state. On the contrary, the X-ray diffraction pattern of the compact, shown in FIG. 1A, remarkable changes are present at peaks of the {100} plane and the {200} plane derived from the oriented grains. Accordingly, it becomes possible to obtain a peak (see FIG. 1C) corresponding to the oriented grains by subtracting peak intensities of an XRD pattern of FIG. 2 from XRD patterns of FIGS. 1A to 1C. An orientation degree of the compact was obtained by Lotgering method by referring to the peak intensities of the XRD pattern of the oriented grains and the peak intensity of the XRD pattern of only the microscopic powder. As a result, the compact was found to have the average orientation degree of 91%.

Further, the full width at half maximum of the compact was obtained on the rocking curve method. That is, in obtaining the full width at half maximum of the compact, an X-ray diffraction (in θ-method) was conducted with an angle θ fixed at a peak position (θ=a position at about 22°) derived on the {100} plane of the oriented grain. Then, a peak width of intensity with a half of the maximum intensity on the resulting angular wave (in rocking curve) was derived and obtained. As a result, the full width at half maximum of the compact was 8°.

Next, the resulting compacts, each formed in the tape-like configuration, were laminated, press bonded and press rolled, thereby obtaining a plate-like compact with a thickness of 1.5 mm. Subsequently, the resulting plate-like compact was degreased. The degreasing was conducted under a condition with: a heating temperature of 600° C.; heating time of 5 hours; a temperature rising rate of 50° C./h; and a cooling initiated in a furnace. In addition, the plate-like compact subsequent to the greasing was subjected to a CIP treatment under a pressure of 300 MPa.

Next, the resulting compact was sintered to prepare a polycrystalline body (in sintering step).

During the sintering step, three steps including a temperature-increasing step, a holding step and a cooling step were conducted.

First, the compact was put in a heating furnace, placed under a controlled oxygen environment, which was heated up to a temperature of 1105° C. at a temperature rising rate of 200° C./h (in temperature-increasing step). Thereafter, the heating furnace was kept at such a temperature of 1105° C. for 5 hours (in holding step). Then, the heating furnace was cooled down to a room temperature at a temperature falling rate of 200° C./h (in cooling step).

In such a way, the crystal oriented ceramics was obtained. This was treated as a test piece E1.

An average orientation degree F. of a {100} plane according to the Lotgering method for a plane parallel to a taped surface of the crystal oriented ceramics (test piece E1) was calculated using the Equation 1.

A piezoelectric ceramics (test piece C3), used in calculating the average orientation degree F. of the crystal oriented ceramics according to the Lotgering method, was fabricated upon sintering the above-described non-oriented compact under the same condition as that of the test piece E1. Further a full width at half maximum (FWHM) of the test piece E1 was measured in the same way as that of the compact discussed above. This result is indicated on Table 1 described below.

With the present Example, further, two kinds of the crystal oriented ceramics (test piece E2 and test piece C1) were fabricated in the same way as that of the test piece E1 set forth above. Orientation degrees and full widths at half maximums (FWHM) of these compacts and an orientation degree and a full width at half maximum (FWHM) of the crystal oriented ceramics were measured in the same way as those conducted on the test piece E1 mentioned above. This result is indicated on Table 1.

Further, the crystal oriented ceramics (test piece C2) was fabricated under a manufacturing condition different from that of the test piece E1.

More particularly, in manufacturing the test piece C2, the mixing step, conducted using the impeller mixer for 1 hour, was altered to a mixing step that was conducted in a ball mill for 6 hours. In addition, the shaping step was also altered so as to allow a compact to be formed in a tape shape with a thickness of 200 μm. Except for these altering points, the test piece C2 was manufactured upon conducting the same steps as those conducted for the test piece E1.

For the test piece C2 manufactured in such a way discussed above, orientation degrees and full widths at half maximums of the compact and the crystal oriented ceramics were measured in the same way as those conducted on the test piece E1 mentioned above. This result is indicated on Table 1.

With the present example, further, the non-oriented piezoelectric ceramics (test piece C3), used for measuring the orientation degree according to the Lotgering method, was set to the orientation degree of 0% and a full width at half maximum of the no-oriented piezoelectric ceramics was obtained in the same way as that obtained for the test piece E1. This result is indicated in Table 1.

Next, bulk densities and piezoelectric d₃₃ constants of the test pieces E1 and E2 and the test pieces C1 to C3, manufactured in such ways discussed above, were measured in manners as described below.

(Bulk Density)

First, weights (dry weights) of the respective test pieces in dried states were measured, respectively. Further, the respective test pieces were immersed in water to cause water to penetrate into opened pore portions of the respective test pieces, after which the weights (hydrous weights) of the respective test pieces were measured. Next, volumes of the opened portions present in the respective test pieces were calculated based on a difference between the hydrous weights and the dry weights. In addition, dividing the dry weights of the respective test pieces by a whole of the volumes (a total sum of volumes of areas from which the volumes of the opened pore portions and the opened pore portions are removed) allowed the bulk densities of the respective test pieces to be calculated. This result is indicated on Table 1.

(Piezoelectric d₃₃ Constant)

First, the respective test pieces were ground and processed, respectively, in disc-like test pieces each having top and bottom surfaces parallel to each tape surface and having a thickness ranging from 0.4 to 0.7 nm n with a diameter ranging from 9 to 11 mm. Then, Au baking finish electrode paste (of the type ALP3057 manufactured by SUMITOMO METAL MINING CO., LTD.) was applied onto the top and bottom surface of each test piece by printing and dried, after which each test piece was baked at a temperature of 850° C. for 10 minutes using a mesh-belt furnace. Thus, each test piece was obtained with each electrode formed with a thickness of 0.01 mm. Further, for the purpose of removing embossed portions inevitably formed on each electrode at an outer circumferential periphery thereof in a height of several micrometers due to printing, each disc-like test piece was subjected to cylindrical grinding in a final profile with a diameter of 8.5 mm. Thereafter, polarization treatments were conducted in a vertical direction, thereby obtaining piezoelectric elements of five kinds each having an entire surface electrode. The piezoelectric constant (d₃₃) of each of the resulting piezoelectric elements was measured in room temperature using a d₃₃ meter (ZJ-3D: manufactured by Institute of Academia Sinica). The result is indicated on Table 1.

TABLE 1

| | Compact | | Crystal Oriented Ceramics | | | |
|---|---|---|---|---|---|---|
| | | Full Width | | Full Width | | Piezoelectric |
| Test | Orienta. | at Half | Orienta. | at Half | Bulk | d₃₃ |
| Piece | degree | Maximum | degree | Maximum | Density | Constant |
| No. | (%) | (°) | (%) | (°) | (g/cm³) | (pm/V) |
| E1 | 91 | 8 | 94 | 7 | 4.71 | 302.8 |
| E2 | 82 | 12 | 91 | 10 | 4.68 | 288.4 |
| C1 | 82 | 18 | 86 | 15 | 4.65 | 234.6 |
| C2 | 65 | 22 | 70 | 18 | 4.53 | 215.4 |
| C3 | 0 | — | 0 | 38 | 4.88 | 158.2 |

As will be understood from Table 1, the crystal oriented ceramics (Test Pieces E1 and E2), manufactured using compacts having an orientation degree of 80% or more with a full width at half maximum of 15° or less, have extremely high orientation degrees with increased bulk densities. Such crystal oriented ceramics can exhibit extremely excellent piezoelectric d₃₃ constants. On the contrary, the crystal oriented ceramics (Test Pieces C1 to C3), manufactured using compacts having an orientation degree less than 80% with a full width at half maximum exceeding a value of 15′, have inadequate orientation degrees with relatively low piezoelectric d₃₃ constants. Also, the compacts used in manufacturing the test pieces E1, E2 and C1 have been manufactured under nearly similar conditions. However, variations take place not only in the orientation degree but also in the full width at half maximum with a resultant occurrence of a difference in orientation degree of finally obtained crystal oriented ceramics. According, it is turned out that even if the compacts are manufactured in the identical condition, the compacts have orientation degrees and full widths at half maximums at varying rates.

FIG. 2 shows the relationship between an orientation degree of a compact according to a Lotgering method and a full width at half maximum of the compact according to a rocking curve method. As will be understood from this drawing, it is turned out that variation takes place in the full width at half maximum according to the rocking curve method in a region where the orientation degree according to the Lotgering method is greater than 80%. This is considered because variation takes place in inclination of each oriented grain per se. Thus, for a crystal oriented ceramics with an increased orientation degree to be reliably obtained, it will be important to take a focus not only on the orientation degree of the Lotgering method but also on the fall width at half maximum according to the rocking curve method.

Like the present example, after having manufactured compacts, selecting those having the orientation degree of 80% or more with the full width at half maximum of 15° or less results in a capability of reliably manufacturing a crystal oriented ceramics with an extremely increased orientation degree.

Now, a method of manufacturing a crystal oriented ceramics according to a second aspect of the present invention will be described below in detail.

According to the second aspect of the present invention, the method of manufacturing the crystal oriented ceramics comprises a preparing step, a mixing step, a shaping step and a sintering step.

The method of manufacturing the crystal oriented ceramics according to the second aspect of the present invention differs from the method of manufacturing the crystal oriented ceramics according to the first aspect of the present invention in respect of a step of preparing an anisotropically shaped powder and, therefore, description will be made with a focus on such a differing point.

That is, in the preparing step forming part of the manufacturing method according to the second aspect of the present invention, the full width at half maximum (FWHM) of the oriented plane of the anisotropically shaped powder is measured according to the rocking curve method. Then, the anisotropically shaped powder having the full width at half maximum of 10° or less is adopted as raw material powder for the crystal oriented ceramics.

When using the anisotropically shaped powder having the full width at half maximum of greater than 10°, variation takes place in finally resulting crystal oriented ceramics. This results in a risk to occur with the production of a crystal oriented ceramics with low piezoelectric characteristic.

The full width at half maximum according to the rocking curve method can be measured in, for instance, a manner as described below.

That is, an X-ray diffraction is conducted on the anisotropically shaped powder with an angle θ fixed at a peak position resulting from the oriented plane. Then, a peak width of intensity with a half of the maximum intensity on the resulting X-ray diffraction pattern (in an angular wave) is obtained and set to the full width at half maximum.

The full width at half maximum according to the rocking curve method may be preferably measured with the anisotropically shaped powder arrayed on a substrate in a single layer.

That is, the full width at half maximum according to the rocking curve method may be preferably measured on the anisotropically shaped powder arrayed on the substrate in the single layer.

In this case, the full width at half maximum of the anisotropically shaped powder can be reliably conducted. This results in a capability of manufacturing a crystal oriented ceramics with increased piezoelectric characteristic in a further reliable manner.

Examples of the substrate may include, for instance, a smoothly shaped glass substrate or the like.

A dispersion liquid may be preferably prepared upon dispersing the anisotropically shaped powder into an alcohol-family organic solvent with the use of an ultrasonic disperser to allow the resulting dispersion liquid to fall in drops onto the substrate after which the dispersion liquid droplets are dried to array the anisotropically shaped powder on the substrate in the single layer.

In this case, the anisotropically shaped powder can be arrayed on the substrate in the single layer in a simplified manner. Further, by using the alcohol-family organic solvent, the anisotropically shaped powder can be easily dried on the substrate. Examples of the alcohol-family organic solvent may include, for instance, ethanol, propanol, isopropyl alcohol (IPA), butanol and pentanol or the like.

The anisotropically shaped powder may be preferably dispersed in the alcohol-family organic solvent at a concentration ranging from 2 to 4 wt %.

If the anisotropically shaped powder has a concentration less than 2 wt %, then it becomes difficult to obtain adequate strength in peak intensity of an X-ray diffraction pattern when measuring the full width at half maximum according to the rocking curve method. This results in difficulty of measuring the full width at half maximum in a reliable manner. On the other hand, if the anisotropically shaped powder has a concentration exceeding 4 wt %, a difficulty is encountered for the anisotropically shaped powder to be arrayed on the substrate in a single layer.

Next, the microscopic powder has one-third or less that of a grain diameter of the anisotropically shaped powder.

If the grain diameter of the microscopic powder exceeds one-third that of the grain diameter of the anisotropically shaped powder; then it becomes difficult to form the raw material mixture so as to allow the oriented planes of the anisotropically shaped powder to be oriented in a nearly identical direction. Moreover, the grain diameters of the anisotropically shaped powder and the microscopic powder refer to diameters the lengthiest axes, respectively.

The composition of the microscopic powder can be determined in accordance with the composition of the anisotropically shaped powder and the composition of the isotropic perovskite-based compound to be manufactured as expressed by, for instance, the general formula (1) or the general formula (2). Further, examples of the microscopic powder may include, for instance, an oxide powder, a composite oxide powder, a hydroxide powder, carbonates, nitrates and oxalates, or alkoxide or the like.

Examples of the microscopic powder may include those that react with the anisotropically shaped powder when sintered therewith to produce a targeted isotropic perovskite-based compound expressed by, for instance, the general formula (1) or the general formula (2).

Further, the anisotropically shaped powder and the microscopic powder may preferably have compositions different from each other that allow a chemical reaction to occur between the anisotropically shaped powder and the microscopic powder during the sintering step for producing the isotropic perovskite-based compound.

In this case, it becomes possible to simply manufacture a crystal oriented ceramics in a composite composition as set forth above.

Furthermore, the microscopic powder may be of the type that reacts with the anisotropically shaped powder for producing only the targeted isotropic perovskite-based compound or of the type that produces both the targeted isotropic perovskite-based compound and a surplus component. If the surplus component is produced in reaction between the anisotropically shaped powder and the microscopic powder, the surplus component may be preferably of the type that can be thermally or chemically removed in an easy fashion.

Next, in the mixing step, the anisotropically shaped powder and the microscopic powder are mixed to each other to prepare a raw material mixture.

In the mixing step, an amorphous fine powder (hereinafter referred to as “compound fine powder”), composed of a compound made of the same composition as that of the isotropic perovskite-based compound obtained in reaction between the anisotropically shaped powder and the microscopic powder, may be added to the anisotropically shaped powder and the microscopic powder that are blended at a given ratio. In addition, a sintering aids such as, for instance, CuO or the like may be added to the anisotropically shaped powder and the microscopic powder. Adding the compound fine powder or a sintering aid to the substances mentioned above provides an advantageous effect of easily accelerating the densification of a sintered body.

Moreover, when blending the compound fine powder, if a blending ratio of the anisotropically shaped powder increases in excess, then a blending ratio of the anisotropically shaped powder occupied in a whole of the raw material inherently decreases with all accompanying drop in an orientation degree of a specific crystal plane. Accordingly, the compound fine powder may preferably have an optimized blending ratio that is selected depending on a required density and an orientation degree of the sintered body.

In producing the isotropic perovskite-based compound expressed by the general formula (1), the anisotropically shaped powder may preferably have a blending ratio to allow one or plural constituent elements of the anisotropically shaped powder to cause the A-site of the general formula (1) to be occupied at a ratio ranging from 0.01 to 70 at % and, more preferably, a ratio ranging from 0.1 to 50 at % and, most preferably, a ratio ranging from 1 to 10 at %. As used herein, the term “at %” refers to a proportion of the number of atoms expressed in percentage.

Further, the raw material mixture may preferably contain additive element of more than one kind selected from metallic elements belonging to Groups 2 to 15 in a Periodic Table, semi-metal elements, transition metal elements, noble metal elements and alkaline-earth metals.

In this case, it becomes possible to manufacture the crystal oriented ceramics composed of the polycrystalline body containing the additive element. This results in improvements in piezoelectric characteristics such as a piezoelectric d₃₃ constant, an electromechanical coupling coefficient Kp and a piezoelectric g₃₁ constant or the like, and dielectric characteristics such as a relative permittivity and a dielectric loss or the like. Although the additive element may be added in substitution to the A-site and the B-site of the compound expressed by the general formula (1), the additive element may also be externally added to such a compound expressed by the general formula (1) to be present in grains thereof or on grain boundaries thereof.

Examples of a concrete method of permitting the raw material mixture to contain the additive element may include, for instance, various methods as described below.

That is, the additive element may be preferably added when synthesizing the anisotropically shaped powder during the preparing step.

Further, the additive element may be preferably added when synthesizing the microscopic powder during the preparing step.

Furthermore, the additive element may be preferably added to the microscopic powder and the anisotropically shaped powder during the mixing thereof.

By adding the additive element in such methods, the raw material mixture can be simply obtained in a composition containing the additive element. With the raw material mixture shaped and sintered, the crystal oriented ceramics can be obtained in a structure including a polycrystalline body containing the additive element.

In particular; examples of the additive element may include, for instance, Mg, Ca, Sr, Ba, Sc, Ti, V; Cr, Mn, Fe, Co, Ni, Cu, Zn, Y, Zr, Mo, Hf; W, Re, Pd, Ag, Ru, Rh, Pt, Au, Ir, Os, B. Al, Ga, In, Si, Ge, Sn and Bi or the like.

Further, the additive element may be added in simple substances or may be added as oxides or compounds containing the additive element.

Moreover, the additive element may be preferably added to 1 mol of the isotropic perovskite-based compound expressed by the general formula (1), obtained in the sintering step, in a proportion ranging from 0.0001 to 0.15 mol.

If the additive element is less than 0.0001 mol, there is a risk of difficulty occurring adequately causing the additive element to exhibit improving effects on the piezoelectric characteristics or the like. On the contrary, if the additive element exceeds 0.15 mol, there is another risk to occur with a drop in the piezoelectric characteristics and the dielectric characteristics of the crystal oriented ceramics.

In the mixing step, further, a mixing ratio of the additive element may be preferably adjusted to allow the additive element to be added in substitution to an element of more than one kind of any one of an A-site element and/or a B-site element of the isotropic perovskite-based compound in the sintering step at a ratio ranging from 0.01 to 15 at %.

In this case, it becomes possible to obtain the crystal oriented ceramics with the additive element added in substitution to the isotropic perovskite-based compound. Such a crystal oriented ceramics can exhibit further increased piezoelectric characteristics such as the piezoelectric d₃₃ and the electromechanical mechanical coupling constant Kp and further increased dielectric characteristics such as relative permittivity ε_{33T}/ε₀.

If the additive element is less than 0.01 at %, there is a risk to occur with difficulty of adequately obtaining improving effects of the piezoelectric characteristics and the dielectric characteristic of the crystal oriented ceramics. In contrast, if the additive element exceeds 15 at %, another risk arises with the occurrence of drops in the piezoelectric characteristics and the dielectric characteristics. More preferably, the ratio of the additive element to be mixed may lay in a value ranging from 0.01 to 5 at % and, more preferably, 0.01 to 2 at % and, most preferably, 0.05 to 2 at %.

As used herein, the term “at %” refers to a proportion of the number of substituted atoms expressed in percentage against the number of atoms of Li, K, Na, Nb, Ta and Sb in the compound expressed by the general formula (1).

In the mixing step, the anisotropically shaped powder, the microscopic powder and the compound fine powder and the sintering aids to be blended depending on needs may be mixed in a dry state or in a wet state upon adding suitable dispersant such as water, alcohol or the like. When this takes place, other elements of more than one kind selected from a binder, a plasticizer and a dispersant or the like may be added depending on needs.

Next, the shaping step will be described below.

The shaping step represents a step of shaping the raw material mixture into a compact so as to allow the anisotropically shaped powder to have the oriented planes oriented in the nearly identical direction.

Examples of the shaping method may suffice to include a method that enables the anisotropically shaped powder to be oriented.

Examples of the shaping method to cause the anisotropically shaped powder to have a plane orientation may include, for instance, a doctor-blade method, a press-forming method and press-rolling method or the like.

For increasing a thickness of or increasing an orientation degree of the compact (hereinafter suitably referred to as “plane-oriented compact”) with the anisotropically shaped powder having the plane orientation, the plane-oriented compact may be subjected to additional treatments (hereinafter referred to as “plane-orienting treatment”) such as stacking with pressure bonding, pressing and press-rolling or the like.

In this case, although the plane-orienting treatment of any one kind may be conducted on the plane-oriented compact, it may be also possible to conduct the plane-orienting treatments of greater than two kinds. Further, the plane-orienting treatment of one kind may be repeatedly conducted on the plane-oriented compact and, furthermore, the plane-orienting treatments of greater than two kinds may also be repeatedly conducted plural times, respectively.

In the shaping step, further, the compact may be preferably shaped in a tape configuration with a thickness of 30 μm or more with front and rear surfaces having compact orientation degrees with a difference falling in a value of 10% or less.

If the thickness is less than 30 μm, there is a risk to occur for the compact to be extremely difficult to be handled during fabrication. Further, if the difference in orientation degrees exceeds 10%, then a risk arises with the occurrence of difficulty of obtaining favorable characteristics due to resulting increased variation in orientation degree of an internal area of the crystal oriented ceramics obtained after the sintering step. More preferably, the compact orientation degree may have the difference of 5% or less and, further preferably, 3% or less.

Now, the sintering step will be described below.

The sintering step represents a step of heating the compact for sintering the anisotropically shaped powder and the microscopic powder. In the sintering step, the compact is heated with a progress in sintering, thereby producing a crystal oriented ceramics formed in a polycrystalline body having an isotropic perovskite-based compound in a principal phase. When this takes place, reacting the anisotropically shaped powder and the microscopic powder results in the production of the isotropic perovskite-based compound expressed by the general formulae (1) or (2). In the sintering step, moreover, a surplus component is concurrently produced depending on the compositions of the anisotropically shaped powder and/or the microscopic powder.

The sintering step is carried out at an optimum heating temperature selected in accordance with the compositions of the anisotropically shaped powder and the microscopic powder in use and the composition of the crystal oriented ceramics to be manufactured. This allows the reaction and/or the sintering to be progressed at high efficiency while growing a reactant with a composition to be targeted.

In manufacturing the crystal oriented ceramics composed of the compound expressed by the general formula (2) upon using the anisotropically shaped powder A having the composition KNN as the anisotropically shaped powder, the sintering step can be conducted at heating temperatures ranging from 900° C. to 1300° C. Among values of such a temperature range, a further optimum temperature may be determined depending on the composition of the compound expressed by the general formula (2) representing a target substance. In addition, optimum time for the heating may be selected depending on the heating temperature so as to obtain a desired sintering density.

Further, in a case where the surplus component is produced due to reaction between the anisotropically shaped powder and the microscopic powder, the surplus component may remain in a sintered body as a sub phase. Moreover, the surplus component may be removed from the sintered body. In removing the surplus component from the sintered body, various methods may be taken including, for instance, the thermally removing method or the chemically removing method as set forth above.

Examples of the thermally removing method may include a method in which, for instance, a sintered body (hereinafter referred to as “an intermediate sintered body”) with the compound, expressed by the general formula (2), and the surplus component being produced is heated at a given temperature to volatilize the surplus component. More particularly, examples of a suitable method include a method of heating the intermediate sintered body at a temperature causing volatilization of the surplus component for a long period of time under a reduced pressure or an oxygen environment.

For the heating temperature for the surplus component to be thermally removed, an optimum temperature may be selected depending on the compositions of the compound, expressed by the general formula (2), and the surplus component so as to accelerate the volatilization of the surplus component at increased efficiency while minimizing the formation of a by-product. With the surplus component formed with, for instance, a single-phase bismuth oxide, the heating temperature may preferably lay in a range from 800° C. to 1300° C. and, more preferably, in a range from 1000° C. to 1200° C.

Further, examples of the chemically removing method may include a method of immersing the intermediate sintered body in treatment liquid with property of dissolving only, for instance, the surplus component which in turn is extracted. When this takes place, treatment liquid to be used may include optimum liquid selected depending on the compositions of the compound, expressed by the general formula (2), and the surplus component. For the surplus component formed with the single-phase bismuth oxide, examples of such treatment liquid may include, for instance, acids such as nitric acid and hydrochloric acid or the like. Especially, nitric acid is suitable as treatment liquid for chemically extracting the surplus component containing bismuth oxide as a principal constituent.

The reaction between the anisotropically shaped powder and the microscopic powder and the removal of the surplus component may be conducted at any timing among concurrent timing, sequential timing and discrete timing. For instance, when directly heating the compact under a reduced pressure or an evacuated environment to a temperature at which both of the reaction between the anisotropically shaped powder and the microscopic powder and the volatilization of the surplus component are progressed at high efficiencies for thereby removing the surplus component concurrent with the reaction. In addition, during the reaction between the anisotropically shaped powder and the microscopic powder, the surplus component may be substituted to the compound expressed by the general formula (2) and representing a target substance or may be placed in the crystal grains and/or the grain boundaries as set forth above.

In another alternative, the surplus component may be removed upon heating the compact under, for instance, an atmospheric or oxygen atmosphere at a temperature causing the reaction between the anisotropically shaped powder and the microscopic powder to be efficiently accelerated to form the intermediate sintered body after which in succeeding step, the intermediate sintered body is heated under the atmospheric or oxygen atmosphere at a temperature efficiently accelerating the volatilization of the surplus component to be removed. In addition, after the intermediate sintered body is produced, the intermediate sintered body may be continuously heated under the atmospheric or oxygen atmosphere at a temperature causing the volatilization of the surplus component at high efficiency for a long period of time for thereby removing the surplus component.

Furthermore, for instance, the intermediate sintered body may be produced and cooled down to a room temperature, after which the intermediate sintered body is immersed in treatment liquid to chemically remove the surplus component. In another alternative, the intermediate sintered body may be produced and cooled up to the room temperature after which the intermediate sintered body is heated at a given temperature under a given atmosphere for thereby thermally removing the surplus component.

In a case where the compact, obtained in the shaping step, contains a resin component such as a binder, heat treatment may be conducted with a view to achieving a main object of degreasing before the sintering step is conducted. In such a case, a degreasing temperature may be set to a temperature adequate for thermally decomposing at least the binder or the like. However, in another case where an easy-to-volatilize substance (such as, for instance, Na compound or the like) is contained in a raw material mixture, the degreasing may be preferably conducted at temperatures of 500° C. or less.

During the degreasing of the compact, further, the orientation degree of the anisotropically shaped powder forming the compact often decreases or a cubical expansion occurs in the compact. In such a case, after conducting the degreasing, a cold isostatic pressing (CIP) treatment may be preferably conducted on the compact before the heat treating treatment is conducted. This enables a reduction in the orientation degree caused by the degreasing or a decrease in a sintering density resulting from cubical expansion of the compact.

Further, under a circumstance where the surplus component is produced due to the reaction between the anisotropically shaped powder and the microscopic powder, when removing the surplus component, the cold isostatic pressing treatment may be conducted on the intermediate sintered body from which the surplus component is removed, after which the intermediate sintered body may be sintered again.

Moreover, for increasing density and orientation degree of the sintered body, a hot press treatment may be further conducted on the sintered body subsequent to the heat treatment. In addition, the method of adding the compound fine powder and other methods of the CIP treatment and the hot press treatment or the like may be combined in use.

With the manufacturing method according to the second aspect of the present invention, as set forth above, the anisotropically shaped powder A, composed of the compound expressed by the general formula (4), is synthesized using the reactive template composed of the anisotropically shaped powder B composed of the layered perovskite-based compound available to be easily synthesized. Then, using the anisotropically shaped powder A as the reactive template allows the crystal oriented ceramics to be manufactured. In this case, even if the compound, expressed by the general formula (2), has the crystal lattice with small anisotropy, the crystal oriented ceramics with arbitrary crystal plane being oriented can be manufactured at low cost in an easy fashion.

Also, by optimizing the compositions of the anisotropically shaped powder and the reactive raw material B, the crystal oriented ceramics can be synthesized even with the anisotropically shaped powder A in the absence of a surplus A-site element. Therefore, a composition control of the A-site element can be easily conducted, enabling the production of the crystal oriented ceramics formed in the principal phase having the compound expressed by the general formula (2) of a composition that cannot be obtained in a method of the elated art.

Further, examples of the anisotropically shaped powder may include the anisotropically shaped powder B composed of the layered perovskite-based compound. In this case, during the sintering step, the compound, expressed by the general formula (2), can be synthesized when sintered. In addition, optimizing the compositions of the anisotropically shaped powder B and the reactive raw material to be oriented in the compact enables a target compound, expressed by the general formula (2), to be synthesized, while exhausting the A-site element in excess from the anisotropically shaped powder B as the surplus component.

Furthermore, when using the anisotropically shaped powder B, generating the surplus component that can be easy to be thermally or chemically removed, as the anisotropically shaped powder set forth above, a crystal oriented ceramics can be obtained in a structure with a specific crystal plane being oriented. That is, the crystal oriented ceramics is composed of the compound, expressed by the general formula (2), and does not substantially have the surplus A-site element.

### Example 2

Next, an example 2 of the second aspect of the present invention will be described below.

With the present example 2, a crystal oriented ceramics was manufactured in a composition of a polycrystalline body, containing an isotropic perovskite-based compound formed in a principal phase, which has crystal grains with a specific crystal plane ({100} plane) being oriented.

In the present example 2, the crystal oriented ceramics was manufactured in the composition in which 0.0005 mol of Mn is externally added to 1 mol of {Li_{0.065}(K_{0.45}Na_{0.55})_{0.935}}{Nb_{0.83}Ta_{0.09}Sb_{0.08})O₃.

In manufacturing the crystal oriented ceramics of the present example 2, the preparing step, the mixing step, the shaping step and the sintering step were conducted.

In the preparing step, the anisotropically shaped powder and the microscopic powder were prepared. The anisotropically shaped powder was composed of the anisotropically shaped oriented grains composed of the isotropic perovskite-based compound in which the oriented planes were formed with the crystal planes oriented so as to have lattice consistency with the specific crystal plane A. The microscopic powder had an average grain diameter of one-third or less that of the anisotropically shaped powder to produce the isotropic perovskite-based compound when sintered with the anisotropically shaped powder. For the anisotropically shaped powder; a powder was adopted having a full width at half maximum (FWHM) of 10° or less according to the rocking curve method.

In the mixing step, the anisotropically shaped powder and the microscopic powder were mixed to each other, thereby preparing a raw material mixture.

In the shaping step, the raw material mixture was shaped, thereby preparing a compact having the oriented grains with the oriented planes oriented in a nearly identical direction.

In the sintering step, the compact was heated to cause the anisotropically shaped powder and the microscopic powder to be sintered, thereby obtaining the crystal oriented ceramics.

Hereunder, the method of manufacturing the crystal oriented ceramics of the second aspect of the present invention will be described below in detail.

(1) Preparation of Anisotropically Shaped Powder

First, a plate-like powder was synthesized in a composition composed of NaNbO₃ as an anisotropically shaped powder in a manner described below.

That is, a powder of Bi₂O₃, a powder of Na₂CO₃ and a powder of Nb₂O₅ were weighed to achieve a composition of Bi_{2.5}Na_{3.5}Nb₅O₁₈, upon which these powders were subjected to wet blending. Then, 50 wt % of NaCl was added as flux to the resulting raw material for dry blending for one hour. Next, the resulting mixture was put in a platinum crucible and heated under a condition at a temperature of 850° C. for one hour. Flux was completely soluble and, thereafter, the resulting mixture was heated under a condition at a temperature of 1100° C. for two hours, thereby synthesizing Bi_{2.5}Na_{3.5}Nb₅O₁₈. Also, a temperature-increasing rate was set to 200° C./hr with the temperature lowered in a furnace cooling. After cooling, hot-water washing was carried out to remove flux from a reactant, thereby obtaining a powder (anisotropically shaped powder B) of Bi_{2.5}Na_{3.5}Nb₅O₁₈. The resulting powder of Bi_{2.5}Na_{3.5}Nb₅O₁₈ was a plate-like powder with an oriented plane (maximum plane) placed on a {001} plane.

Next, a powder of Na₂CO₃ (reactive material), required for NaNbO₃ to be synthesized, was added to the powder of Bi_{2.5}Na_{3.5}Nb₅O₁₈ for mixing. NaCl was added as flux to the resulting mixture and the resulting raw material was put into the platinum crucible for heat treatment at a temperature of 950° C. for eight hours. Since the resulting reactant contained the powder of Bi₂O₃ in addition to the powder of NaNbO₃, flux was removed from the reactant and the resulting reactant was placed in HNO₃(1N) for dissolving Bi₂O₃ formed as a surplus component. Further, this solution was filtered to separate a powder (NaNbO₃ powder) composed of NaNbO₃, which in turn was washed at a temperature of 80° C. using ion-exchange water. In such a way, NaNbO₃ powder was obtained as an anisotropically shaped powder (in preparing step).

The resulting NaNbO₃ powder was a plate-like powder, having a pseudocubic {100} plane placed on a maximum plane (oriented plane) with an average grain diameter (in an average of maximum diameters) of 15 μm, which has an aspect ratio in the order of approximately 10 to 20.

Then, the full width at half maximum (FWHM) of the oriented plane ({100} plane) of the resulting anisotropically shaped powder was measured according to the rocking curve method.

In particular, first, the anisotropically shaped powder was put in ethanol. The amount of anisotropically shaped powder to be put was set to 3 wt %. Next, the anisotropically shaped powder was homogeneously dispersed at a frequency of 28 kHz for 2 minutes using a ultrasound disperser (Type: SUS-103 manufactured by Shimadzu Rika Corporation), thereby obtaining dispersion liquid. Then, dispersion liquid was dropped on a flat and smooth glass substrate and subsequently dried. This allowed the anisotropically shaped powder to be arrayed on the glass substrate in a single layer.

Subsequently, an X-ray diffraction intensity of the anisotropically shaped powder arrayed on the glass substrate was measured. The X-ray diffraction intensity was measured at an arbitrary angle ranging from 0 to 180° (i.e. ranging from 20° to 50° in the present example 2) by the X-ray diffraction (2θ method) under the condition CuKα radiation at 50 kV/300 mA) using the X-ray diffraction device (Type, RINT-TTR, manufactured by Rigaku Corporation). Next, the X-ray diffraction (20 method) was conducted with the θ-angle fixed to a peak position (at a position of θ=approximately 22°) resulting from the {100} plane. This resulted in a peak width (full width) in intensity in which the maximum intensity of the resulting angular wave (of the rocking curve) is halved. This was treated to be the full width at half maximum. As a result, the full width at half maximum was 5°.

(2) Preparation of Microscopic Powder

Na₂CO₃ powder, K₂CO₃ powder, Li₂CO₃ powder, Nb₂CO₅ powder, Ta₂CO₅ powder, Sb₂O₅ powder and MnO₂ powder, each of which has a purity of 99.99% or more, were weighed in a composition in which 0.05 mol of NaNbO₃ was subtracted from 1 mol of a stoichiometric composition of {{Li_{0.065}(K_{0.45}Na_{0.55})_{0.935}}{Nb_{0.83}Ta_{0.09}Sb_{0.08})O₃+0.0005 mol of Mn}. Then, the resulting blend was added to an organic solvent as media in a ZrO₂ ball mill and subjected to wet blending for 20 hours. Thereafter; the resulting mixture was calcined at a temperature of 750° C. for 5 hours, after which the resulting substance was further subjected to wet blending using the organic solvent as media in the ZrO₂ ball for 20 hours, thereby obtaining a calcined powder (microscopic powder) with an average grain diameter of approximately 0.5 μm (in preparing step).

(3) Preparation of Crystal Oriented Ceramics

The microscopic powder, prepared in such a way discussed above, was weighed and subjected to wet blending using the organic solvent as media in the ZrO₂ ball for 20 hours, Thereafter, the anisotropically shaped powder was added to the microscopic powder in a blending ratio such that a target ceramic composition had an amount of Na (A-site element) among which 5 at % of Na was supplied from the anisotropically shaped powder. In addition, 10 parts by weight of polyvinyl butyral (PVB) resin as a binder and 5 parts by weight of butyl phthalate as a plasticizer were added to 100 parts by weight of a mixture of the anisotropically shaped powder and the microscopic powder, upon which the resulting blend was mixed for 1 hour using a mixer to obtain a raw material mixture slurry (in mixing step).

Next, the mixture slurry was shaped in tape-like configurations each with a thickness of 100 μm using a doctor blade device, thereby obtaining compacts (in shaping step). Each of the compact contained the anisotropically shaped powder composed of plate-like oriented grains oriented in a nearly identical direction.

Next, the resulting compacts, each formed in the tape-like configuration, were stacked, press bonded and press rolled, thereby obtaining a plate-like compact with a thickness of 1.5 mm. Subsequently, the resulting plate-like compact was degreased. The degreasing was conducted under a condition with: a heating temperature of 600° C.; heating time of 5 hours; a temperature rising rate of 50° C./h; and a cooling rate in furnace cooling. In addition, the plate-like compact subsequent to the greasing was subjected to a CIP treatment under a pressure of 300 MPa.

Next, the resulting compact was sintered to prepare a polycrystalline body (in sintering step).

During such a sintering step, three steps were conducted including a temperature-increasing step, a holding step and a cooling step.

First, the compact was put in a heating furnace, placed under a controlled oxygen environment, which was heated up to a temperature of 1105° C. at a temperature rising rate of 200° C./h (in temperature-increasing step). Thereafter, the heating furnace was kept at such a temperature of 1105° C. for 5 hours (in holding step). Then, the heating furnace was cooled down to a room temperature at a temperature falling rate of 200° C./h (in cooling step).

In such a way, the crystal oriented ceramics was obtained. This was treated as a test piece E3.

Next, an average orientation degree F. of a {100} plane of the resulting crystal oriented ceramics (test piece E3) was measured.

More particularly, the X-ray diffraction intensity of the test piece E3 was measured under the condition Cu—Kα radiation at 50 kV/300 mA using the X-ray diffraction device (Type: RINT-TTR, manufactured by Rigaku Corporation). Then, the average orientation degree F. of the {100} plane was calculated in accordance with the Lotgering method by referring to Equation 1 set forth above.

Also, a piezoelectric ceramics (test piece C6), used in calculating the average orientation degree F. of the crystal oriented ceramics according to the Lotgering method, was fabricated in a manner described below.

That is, first, Na₂CO₃ powder, K₂CO₃ powder, Li₂CO₃ powder, Nb₂O₅ powder, Ta₂O₅ powder, Sb₂O₅ powder and MnO₂ powder were weighed in a composition of {{Li_{0.065}(K_{0.45}Na_{0.55})_{0.935}}{Nb_{0.83}Ta_{00.9}Sb_{0.08})O₃+0.0005 mol of Mn}. The resulting blend was subjected to wet blending using the organic solvent as media in the ZrO₂ ball for 20 hours. Thereafter, the resulting mixture was calcined at a temperature of 750° C. for 5 hours, after which the resulting substance was further subjected to wet blending using the organic solvent as media in the ZrO2 ball for 20 hours, thereby obtaining a calcined powder with an average grain diameter of approximately 0.5 μm. Further, 10 parts by weight of polyvinyl butyral (PVB) resin as a binder and 5 parts by weight of dibutyl phthalate as a plasticizer were added to a total sum of 100 parts by weight of respective powders (microscopic powders) in the organic solvent as media, upon which the resulting blend was subjected to wet blending in the ZrO₂ ball for 20 hours, thereby obtaining a raw material mixture slurry.

Next, the mixture slurry was shaped in tape-like configurations each with a thickness of 100 μm using the doctor blade device, thereby obtaining compacts each with non-orientation structure (non-oriented compact). Subsequently, the non-oriented compacts were stacked, press bonded, degreased and sintered under the same condition as that of the test piece E3, thereby obtaining a non-oriented piezoelectric ceramics (test piece C6). The X-ray diffraction intensity of the non-oriented piezoelectric ceramics was also measured, thereby calculating an average orientation degree F. (100) of the crystal oriented ceramics (test piece E3) in accordance with the Lotgering method.

Further, the full width at half maximum of the crystal oriented ceramics (test piece E3) was obtained on the rocking curve method. That is, in obtaining the full width at half maximum of the compact, the X-ray diffraction (in θ-method) was conducted with the θ-angle fixed at the peak position (a position with θ=approximately 22°) derived on the {100} plane in the X-ray diffraction pattern obtained in measurement of the orientation degree described above. Then, a peak width was obtained for measurement in intensity in which the maximum intensity of the resulting angular wave (on rocking curve) was halved. This result is indicated on Table 2 described below.

With the present embodiment, further, anisotropically shaped powders of three kinds were produced under the nearly same condition as that used in producing the test piece E3. However, these anisotropically shaped powders were finally pulverized with alteration made in grain diameters to be different from those of the anisotropically shaped powder used in manufacturing the test piece E3. More particularly, the anisotropically shaped powders were prepared in sizes with three different average diameters of 12 μm, 8 μm and 5 μm, respectively. Upon measuring the full widths at half maximums of the {100} planes of these anisotropically shaped powders according to the rocking curve method, the full widths at half maximums for the average diameters of 12 μm, 8 μm and 5 μm marked 8°, 12° and 15°, respectively. Accordingly, in order to have the anisotropically shaped powder to have the full width at half maximum falling in a value of 10° or less, it will be understood that the anisotropically shaped powder may preferably have an average grain diameter ranging from 10 μm to 15 μm.

Next, using these anisotropically shaped powders, crystal oriented ceramics of three kinds (test piece E4 and test pieces C4 and C5) were manufactured. These test pieces were manufactured in the same way as that of the test piece E3 set forth above except for a point in that the anisotropically shaped powders had the full widths at half maximums different from each other.

The orientation degrees and the full widths at half maximums of these test pieces E4 and C4 and C5 were also measured in the same manner as those of the test piece E4. This result is indicated on Table 2.

With the example 2, further, the full width at half maximum of the non-oriented piezoelectric ceramics (test piece C6), used in measuring the orientation degree according to the Lotgering method, was obtained in the same way as that of the test piece E3 with the orientation degree of the test piece C6 being set to 0%. This result is indicated on Table 2.

Next, bulk densities and piezoelectric d₃₃ constants of the test pieces E3 and E4 and the test pieces C4 to C6, manufactured in such ways discussed above, were measured in manners as described below.

(Bulk Density)

First, weights (dry weights) of the respective test pieces in dried states were measured, respectively. Further, the respective test pieces were immersed in water to cause water to penetrate into opened pore portions of the respective test pieces, after which the weights (hydrous weights) of the respective test pieces were measured. Next, volumes of the opened portions present in the respective test pieces were calculated based on a difference between the hydrous weights and the dry weights. In addition, dividing the dry weights of the respective test pieces by a whole of the volumes (a total sum of volumes of areas from which the volumes of the opened pore portions and the opened pore portions are removed) allowed the bulk densities of the respective test pieces to be calculated. This result is indicated on Table 2.

(Piezoelectric d₃₃ Constant)

First, the respective test pieces were ground and processed, respectively, in disc-like test pieces each having top and bottom surfaces parallel to each tape surface and having a thickness ranging from 0.4 to 0.7 mm with a diameter ranging from 9 to 11 mm. Then, Au baking finish electrode paste (of the type ALP3057 manufactured by SUMITOMO METAL MINING CO., LTD.) was applied onto the top and bottom surface of each test piece by printing and dried, after which each test piece was baked at a temperature of 850° C. for 10 minutes using a mesh-belt furnace. Thus, each test piece was obtained with each electrode formed with a thickness of 0.01 mm. Further, for the purpose of removing embossed portions inevitably formed on each electrode at an outer circumferential periphery thereof in a height of several micrometers due to printing, each disc-like test piece was subjected to cylindrical grinding in a final profile with a diameter of 8.5 mm. Thereafter, polarization treatments were conducted in a vertical direction, thereby obtaining piezoelectric elements of five kinds each having an entire surface electrode. The piezoelectric constant (d₃₃) of each of the resulting piezoelectric elements was measured in room temperature using a d₃₃ meter (ZJ-3D: manufactured by Institute of Academia Sinica). The result is indicated on Table 2.

TABLE 2

| | Anisotropically | | | | |
|---|---|---|---|---|---|
| | Shaped | Crystal Oriented Ceramics | | | |
| | Powder | | Full Width | | Piezoelectric |
| | Full Width at | Orienta. | at Half | Bulk | d₃₃ |
| Test | Half Maximum | degree | Maximum | Density | Constant |
| Piece No. | (°) | (%) | (°) | (g/cm³) | (pm/V) |
| E3 | 5 | 94 | 7 | 4.71 | 302.8 |
| E4 | 8 | 91 | 10 | 4.68 | 288.4 |
| C4 | 12 | 86 | 15 | 4.65 | 234.6 |
| C5 | 15 | 70 | 18 | 4.53 | 215.4 |
| C6 | — | 0 | 38 | 4.88 | 158.2 |

As will be understood from Table 2, the crystal oriented ceramics (Test Pieces E3 and E4), manufactured using the anisotropically shaped powders each having the full width at half maximum of 10° or less, had extremely high orientation degrees with extremely small full width at half maximum. In addition, the bulk densities of these test pieces marked adequately high levels comparable to the bulk density of the non-oriented piezoelectric ceramics (test piece C3). Such crystal oriented ceramics could exhibit extremely excellent piezoelectric d₃₃ constants as shown in Table 2.

On the contrary, the crystal oriented ceramics (Test Pieces C4 to C6), manufactured using the anisotropically shaped powders each having the full width at half maximum exceeding a value of 10′, had inadequate orientation degrees with relatively low piezoelectric d₃₃ constants.

Also, the anisotropically shaped powders used in manufacturing the test pieces E3 and E4 and C4 to C6 have been manufactured under nearly similar conditions except for a slight difference in grain diameters. However, variations take place in the full width at half maximum. This resulted in the occurrence of a difference in orientation degree of finally obtained crystal oriented ceramics with a resultant variation in piezoelectric characteristic.

According, it is turned out that even when using the anisotropically shaped powders manufactured in the nearly similar conditions, variation takes place in piezoelectric characteristic.

Accordingly, it may be understood from the crystal oriented ceramics of the test pieces E3 and E4 that it is important to selectively use the anisotropically shaped powder with the full width at half maximum of 10° or less. The use of such an anisotropically shaped powder results in a capability of manufacturing a crystal oriented ceramics with an extremely high orientation degree.

While the specific embodiments of the present invention have been described above in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A method of manufacturing a crystal oriented ceramics formed in a polycrystalline body having a principal phase formed of an isotropic perovskite-based compound composed of crystal grains with a specific crystal plane A of each crystal grain being oriented, the method comprising:
preparing an anisotropically shaped powder composed of anisotropically shaped oriented grains formed of a perovskite-based compound with crystal planes, having lattice consistency with the specific crystal plane A, which are oriented to form oriented planes, and a microscopic powder having an average grain diameter one-third or less that of the anisotropically shaped powder and producing the isotropic perovskite-based compound when sintered with the anisotropically shaped powder;
mixing the anisotropically shaped powder and the microscopic powder to prepare a raw material mixture;
shaping the raw material mixture to form a compact so as to allow the oriented planes of the anisotropically shaped powder to be oriented in a nearly identical direction; and
sintering the compact upon heating the same to cause the anisotropically shaped powder and the microscopic powder to be sintered with each other to obtain the crystal oriented ceramics; and
wherein at least one of the anisotropically shaped powder and the compact has a full width at half maximum (FWHM) of 15° or less according to a rocking curve method.

2. The method of manufacturing the crystal oriented ceramics according to claim 1, further comprising:
evaluating the oriented planes of the oriented grains in the compact upon measuring an orientation degree according to a Lotgering method and the full width at half maximum (FWHM) according to the rocking curve method and selecting the compact having the orientation degree of 80% or more with the full width at half maximum (FWHM) of 15° or less.

3. The method of manufacturing the crystal oriented ceramics according to claim 1, wherein:
the step of preparing the anisotropically shaped powder comprises measuring the full width at half maximum (FWHM) of the oriented planes according to the rocking curve method and adopting the anisotropically shaped powder having the full width at half maximum (FWHM) of 10° or less.

4. The method of manufacturing the crystal oriented ceramics according to claim 2, wherein:
the crystal plane A of the crystal oriented ceramics includes a pseudocubic {100} plane and/or a pseudocubic {200} plane.

5. The method of manufacturing the crystal oriented ceramics according to claim 2, wherein:
the oriented planes of the oriented grains have the same planes as the crystal plane A.

6. The method of manufacturing the crystal oriented ceramics according to claim 2, wherein:
the isotropic perovskite-based compound comprises a compound expressed by a general formula (1) of ABO₃ (provided that an A-site element takes a principal component composed of more than one kind selected from a group consisting of K, Na and Li and a B-site element takes a principal component composed of more than one kind selected from a group consisting of Nb, Sb and Ta).

7. The method of manufacturing the crystal oriented ceramics according to claim 2, wherein:
the isotropic perovskite-based compound has a composition expressed by a general formula (2): {Liₓ(K_{1-y}Na_{y})₁₋ₓ}(Nb_{1-z-w}Ta_{z}Sb_{w})O₃ (provided 0≦x≦0.2, 0≦y≦1, ≦0z≦0.4, 0≦w≦0.2 and x+z+w>0).

8. The method of manufacturing the crystal oriented ceramics according to claim 2, wherein:
the oriented grains comprise an isotropic perovskite-based compound expressed by a general formula (3) of ABO₃ wherein an A-site element has a principal component composed of at least one kind selected from the group consisting of K, Na and Li and a B-site element has a principal component composed of at least one kind selected from the group consisting of Nb, Sb and Ta.

9. The method of manufacturing the crystal oriented ceramics according to claim 2, wherein:
the anisotropically shaped powder and the microscopic powder have compositions different from each other that allow a chemical reaction between the anisotropically shaped powder and the microscopic powder during the sintering step for producing the isotropic perovskite-based compound.

10. The method of manufacturing the crystal oriented ceramics according to claim 2, wherein:
the raw material mixture contains an additive element of more than one kind selected from metallic elements belonging to Groups 2 to 15 in a Periodic Table, semi-metal elements, transition metal elements, noble metal elements and alkaline-earth metals.

11. The method of manufacturing the crystal oriented ceramics according to claim 10, wherein:
the additive element is added when synthesizing the anisotropically shaped powder during the preparing step.

12. The method of manufacturing the crystal oriented ceramics according to claim 10, wherein:
the additive element is added when synthesizing the microscopic powder during the preparing step.

13. The method of manufacturing the crystal oriented ceramics according to claim 10, wherein:
the additive element is added to the microscopic powder and the anisotropically shaped powder during the mixing thereof.

14. The method of manufacturing the crystal oriented ceramics according to claim 10, wherein:
the additive element is added such that the additive element takes a proportion ranging from 0.0001 to 0.15 mol to 1 mol of the isotropic perovskite-based compound obtained in the sintering step.

15. The method of manufacturing the crystal oriented ceramics according to claim 10, wherein:
the additive element has a mixing ratio adjusted such that during the sintering step, the additive element is added in substitution at a rate of 0.01 to 15 at % to an element of more than one kind of either one of an A-site element and/or a B-site element of the isotropic perovskite-based compound.

16. The method of manufacturing the crystal oriented ceramics according to claim 3, wherein:
the full width at half maximum according to the rocking curve method is measured with the anisotropically shaped powder arrayed on a substrate in a single layer.

17. The method of manufacturing the crystal oriented ceramics according to claim 16, wherein:
the anisotropically shaped powder is dispersed in an alcohol-family organic solvent to prepare a dispersion liquid using an ultrasonic disperser upon which the dispersion liquid is dropped onto the substrate and then dried to cause the anisotropically shaped powder to be arrayed on the substrate in the single layer.

18. The method of manufacturing the crystal oriented ceramics according to claim 17, wherein:
the anisotropically shaped powder dispersed in the alcohol-family organic solvent at a concentration ranging from 2 to 4 wt %.

19. The method of manufacturing the crystal oriented ceramics according to claim 3, wherein:
the crystal plane A of the crystal oriented ceramics includes a pseudocubic {100} plane and/or a pseudocubic {200} plane.

20. The method of manufacturing the crystal oriented ceramics according to claim 3, wherein:
the oriented planes of the oriented grains have the same planes as the crystal plane A.

21. The method of manufacturing the crystal oriented ceramics according to claim 3, wherein:
the isotropic perovskite-based compound comprises a compound expressed by a general formula (1) of ABO₃ (provided that an A-site element takes a principal component composed of more than one kind selected from a group consisting of K, Na and Li and a B-site element takes a principal component composed of more than one kind selected from a group consisting of Nb, Sb and Ta).

22. The method of manufacturing the crystal oriented ceramics according to claim 3, wherein:
the isotropic perovskite-based compound has a composition expressed by a general formula (2): {Liₓ(K_{1-y}Na_{y})₁₋ₓ}(Nb_{1-z-w}Ta_{z}Sb_{w})O₃ (provided 0≦x≦0.2, 0≦y≦1, 0≦z≦0.4, 0≦w≦0.2 and x+z+w>0).

23. The method of manufacturing the crystal oriented ceramics according to claim 3, wherein:
the oriented grains comprise an isotropic perovskite-based compound expressed by a general formula (3) of ABO₃ wherein an A-site element has a principal component composed of at least one kind selected from the group consisting of K, Na and Li and a B-site element has a principal component composed of at least one kind selected from the group consisting of Nb, Sb and Ta.

24. The method of manufacturing the crystal oriented ceramics according to claim 3, wherein:
the anisotropically shaped powder and the microscopic powder have compositions different from each other that allow a chemical reaction between the anisotropically shaped powder and the microscopic powder during the sintering step for producing the isotropic perovskite-based compound.

25. The method of manufacturing the crystal oriented ceramics according to claim 3, wherein:
the raw material mixture contains an additive element of more than one kind selected from metallic elements belonging to Groups 2 to 15 in a Periodic Table, semi-metal elements, transition metal elements, noble metal elements and alkaline-earth metals.

26. The method of manufacturing the crystal oriented ceramics according to claim 25, wherein:
the additive element is added when synthesizing the anisotropically shaped powder during the preparing step.

27. The method of manufacturing the crystal oriented ceramics according to claim 25, wherein:
the additive element is added when synthesizing the microscopic powder during the preparing step.

28. The method of manufacturing the crystal oriented ceramics according to claim 25, wherein:
the additive element is added to the microscopic powder and the anisotropically shaped powder during the mixing thereof.

29. The method of manufacturing the crystal oriented ceramics according to claim 25, wherein:
the additive element is added such that the additive element takes a proportion ranging from 0.0001 to 0.15 mol to 1 mol of the isotropic perovskite-based compound obtained in the sintering step.

30. The method of manufacturing the crystal oriented ceramics according to claim 25, wherein:
the additive element has a mixing ratio adjusted such that during the sintering step, the additive element is added in substitution at a rate of 0.01 to 15 at % to an element of more than one kind of either one of an A-site element and/or a B-site element of the isotropic perovskite-based compound.
